(19) United States
(12) Patent Application Publication
(10) Pub. No.: US 2024/0126822 A1
(43) Pub. Date: Apr. 18, 2024

(54) METHODS, APPARATUSES AND COMPUTER PROGRAM PRODUCTS FOR GENERATING MULTI-MEASURE OPTIMIZED RANKING DATA OBJECTS

(71) Applicant: Optum, Inc., Minnetonka, MN (US)

(72) Inventors: Laura D. Hamilton, Chicago, IL (US); Ayush Tomar, Morgan Hill, CA (US); Vinit Garg, Fremont, CA (US); Lun Yu, San Francisco, CA (US)

(21) Appl. No.: 18/047,209

(22) Filed: Oct. 17, 2022

(51) Int. Cl. G06F 16/9535; G06F 16/9538

(52) U.S. Cl. CPC G06F 16/9535; G06F 16/9538

(57) ABSTRACT

Methods, apparatuses, systems, computing devices, and/or the like are provided. An example method may include retrieving an initial ranking data object associated with a plurality of search result data objects, retrieving a plurality of relevance score data objects, generating a plurality of ranking comparison score data objects, generating a multi-measure optimized ranking data object associated with the plurality of search result data objects, and performing one or more prediction-based actions based at least in part on the multi-measure optimized ranking data object.

### TECHNOLOGICAL FIELD

Embodiments of the present disclosure relate generally to improving accuracy and relevance of search results. For example, various embodiments of the present disclosure may programmatically generate multi-measure optimized ranking data objects that provide optimized rankings of search result data objects based at least in part on multiple relevance measures and relevance objectives.

### BACKGROUND

A search engine may refer to a software system that is designed to carry out web searches. For example, when a user inputs a search query to the search engine, the search engine generates search results by querying one or more network databases based at least in part on the search query.

However, many search engines are plagued with technical challenges and difficulties, especially when such search engines are implemented to conduct data retrieval in complex network systems. For example, many search engines are not capable of generating personalized search results. As another example, many search engines do not take into consideration the values of the search results when ranking such search results.

### BRIEF SUMMARY

In general, embodiments of the present disclosure provide methods, apparatuses, systems, computing devices, computing entities, and/or the like.

In accordance with various embodiments of the present disclosure, an apparatus is provided. The apparatus may comprise at least one processor and at least one non-transitory memory comprising a computer program code. The at least one non-transitory memory and the computer program code may be configured to, with the at least one processor, cause the apparatus to retrieve an initial ranking data object associated with a plurality of search result data objects, wherein the plurality of search result data objects are associated with a search query data object; retrieve a plurality of relevance score data objects, wherein each of the plurality of relevance score data objects is associated with one of the plurality of search result data objects and one of a plurality of relevance measures; generate a plurality of ranking comparison score data objects associated with the plurality of relevance measures; generate a multi-measure optimized ranking data object associated with the plurality of search result data objects based at least in part on inputting the plurality of ranking comparison score data objects to a multi-measure ranking optimization machine learning model; and perform one or more prediction-based actions based at least in part on the multi-measure optimized ranking data object. In some embodiments, the at least one non-transitory memory and the computer program code are configured to, with the at least one processor, cause the apparatus to: determine, from the plurality of relevance score data objects, a relevance score data object subset associated with the plurality of search result data objects and associated with a relevance measure of the plurality of relevance measures; generate, based at least in part on the relevance score data object subset, a per-measure optimized ranking data object associated with the plurality of search result data objects and the relevance measure; and generate a ranking comparison score data object associated with the relevance measure based at least in part on the per-measure optimized ranking data object and the initial ranking data object.

In some embodiments, when retrieving the initial ranking data object, the at least one non-transitory memory and the computer program code are configured to, with the at least one processor, cause the apparatus to: retrieve a user profile data object associated with the search query data object, wherein the user profile data object comprises user profile metadata; and generate a plurality of user feature vectors associated with the user profile data object based at least in part on the user profile metadata.

In some embodiments, the plurality of user feature vectors comprises one or more of user socio-economics embedding vectors, user demographics characteristics vectors, user search history embedding vectors, and user medical history embedding vectors.

In some embodiments, the at least one non-transitory memory and the computer program code are configured to, with the at least one processor, cause the apparatus to: generate a plurality of query feature vectors based at least in part on the search query data object, wherein the plurality of query feature vectors comprises one or more of query embedding vectors and query-item relevance vectors.

In some embodiments, the at least one non-transitory memory and the computer program code are configured to, with the at least one processor, cause the apparatus to: generate the initial ranking data object based at least in part on the plurality of user feature vectors and the plurality of query feature vectors.

In some embodiments, the plurality of relevance score data objects comprises a plurality of textual relevance score data objects, a plurality of engagement relevance score data objects, and a plurality of outcome relevance score data objects.

In some embodiments, the at least one non-transitory memory and the computer program code are configured to, with the at least one processor, cause the apparatus to: generate a plurality of query feature vectors based at least in part on the search query data object; determine a plurality of search result metadata that are associated with the plurality of search result data objects; and generate the plurality of textual relevance score data objects based at least in part on the plurality of search result metadata and the plurality of query feature vectors.

In some embodiments, the at least one non-transitory memory and the computer program code are configured to, with the at least one processor, cause the apparatus to: retrieve a plurality of search event data objects associated with the plurality of search result data objects, wherein the plurality of search event data objects comprises search result selection metadata; generate one or more attractiveness variable data objects, one or more examination variable data objects, and one or more satisfaction variable data objects associated with the plurality of search result data objects based at least in part on the search result selection metadata; and generate the plurality of engagement relevance score data objects based at least in part on inputting the one or more attractiveness variable data objects, the one or more examination variable data objects, and the one or more satisfaction variable data objects to an engagement relevance machine learning model.

In some embodiments, the plurality of engagement relevance score data objects comprises a plurality of immediate engagement relevance score data objects and a plurality of delayed engagement relevance score data objects.

In some embodiments, the at least one non-transitory memory and the computer program code are configured to, with the at least one processor, cause the apparatus to: retrieve a plurality of search event data objects associated with the plurality of search result data objects, wherein the plurality of search event data objects comprises search result completion metadata; and generate the plurality of immediate engagement relevance score data objects based at least in part on the search result completion metadata.

In some embodiments, the at least one non-transitory memory and the computer program code are configured to, with the at least one processor, cause the apparatus to: determine a post-search observation time period that is associated with the plurality of search result data objects; retrieve a user profile data object that is associated with the search query data object; retrieve a plurality of clinical event data objects that are associated with the user profile data object and the post-search observation time period; retrieve a plurality of search event data objects associated with the plurality of search result data objects; and generate the plurality of delayed engagement relevance score data objects based at least in part on the plurality of clinical event data objects and the plurality of search event data objects.

In some embodiments, the at least one non-transitory memory and the computer program code are configured to, with the at least one processor, cause the apparatus to: determine a clinical event data object associated with a search result data object of the plurality of search result data objects, wherein the search query data object is associated with a user profile data object; generate a cost difference variable data object based at least in part on inputting the user profile data object to an event-true cost-estimation machine learning model and an event-false cost-estimation machine learning model associated with the clinical event data object; and generate an outcome relevance score data object associated with the search result data object based at least in part on the cost difference variable data object.

In some embodiments, the at least one non-transitory memory and the computer program code are configured to, with the at least one processor, cause the apparatus to: identify, from a plurality of user profile data objects and based at least in part on a probability matching machine learning model, a first probability-matched user profile data object subset that is associated with the clinical event data object and a second probability-matched user profile data object subset that is not associated with the clinical event data object; and train the event-true cost-estimation machine learning model based at least in part on the first probability-matched user profile data object subset and the event-false cost-estimation machine learning model based at least in part on the second probability-matched user profile data object subset.

In some embodiments, the at least one non-transitory memory and the computer program code are configured to, with the at least one processor, cause the apparatus to: train the probability matching machine learning model based at least in part on one or more user profile data objects that are associated with the clinical event data object and one or more user profile data objects that are not associated with the clinical event data object.

In accordance with various embodiments of the present disclosure, a computer-implemented method is provided. The computer-implemented method may comprise retrieving an initial ranking data object associated with a plurality of search result data objects, wherein the plurality of search result data objects are associated with a search query data object; retrieving a plurality of relevance score data objects, wherein each of the plurality of relevance score data objects is associated with one of the plurality of search result data objects and one of a plurality of relevance measures; generating a plurality of ranking comparison score data objects associated with the plurality of relevance measures; generating a multi-measure optimized ranking data object associated with the plurality of search result data objects based at least in part on inputting the plurality of ranking comparison score data objects to a multi-measure ranking optimization machine learning model; and performing one or more prediction-based actions based at least in part on the multi-measure optimized ranking data object. In some embodiments, the computer-implemented method comprises determining, from the plurality of relevance score data objects, a relevance score data object subset associated with the plurality of search result data objects and associated with a relevance measure of the plurality of relevance measures; generating, based at least in part on the relevance score data object subset, a per-measure optimized ranking data object associated with the plurality of search result data objects and the relevance measure; and generating a ranking comparison score data object associated with the relevance measure based at least in part on the per-measure optimized ranking data object and the initial ranking data object.

In accordance with various embodiments of the present disclosure, a computer program product is provided. The computer program product may comprise at least one non-transitory computer-readable storage medium having computer-readable program code portions stored therein. The computer-readable program code portions comprise an executable portion configured to retrieve an initial ranking data object associated with a plurality of search result data objects, wherein the plurality of search result data objects are associated with a search query data object; retrieve a plurality of relevance score data objects, wherein each of the plurality of relevance score data objects is associated with one of the plurality of search result data objects and one of a plurality of relevance measures; generate a plurality of ranking comparison score data objects associated with the plurality of relevance measures; generate a multi-measure optimized ranking data object associated with the plurality of search result data objects based at least in part on inputting the plurality of ranking comparison score data objects to a multi-measure ranking optimization machine learning model; and perform one or more prediction-based actions based at least in part on the multi-measure optimized ranking data object. In some embodiments, the computer-readable program code portions comprise the executable portion configured to determine, from the plurality of relevance score data objects, a relevance score data object subset associated with the plurality of search result data objects and associated with a relevance measure of the plurality of relevance measures; generate, based at least in part on the relevance score data object subset, a per-measure optimized ranking data object associated with the plurality of search result data objects and the relevance measure; and generate a ranking comparison score data object associated with the relevance measure based at least in part on the per-measure optimized ranking data object and the initial ranking data object.

The above summary is provided merely for purposes of summarizing some example embodiments to provide a basic understanding of some aspects of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a diagram of an example multi-measure optimized ranking generation platform/system that can be used in accordance with various embodiments of the present disclosure;

FIG. 2 is a schematic representation of an example ranking generation computing entity in accordance with various embodiments of the present disclosure;

FIG. 3 is a schematic representation of an example client computing entity in accordance with various embodiments of the present disclosure;

FIG. 4 is a schematic representation of data communications between an example ranking generation computing entity and example databases in accordance with various embodiments of the present disclosure; and

FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, and FIG. 18 provide example flowcharts and diagrams illustrating example steps, processes, procedures, and/or operations associated with an example multi-measure optimized ranking generation platform/system in accordance with various embodiments of the present disclosure.

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

### I. COMPUTER PROGRAM PRODUCTS, METHODS, AND COMPUTING ENTITIES

Embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Additionally, or alternatively, embodiments of the present disclosure may be implemented as a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media may include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

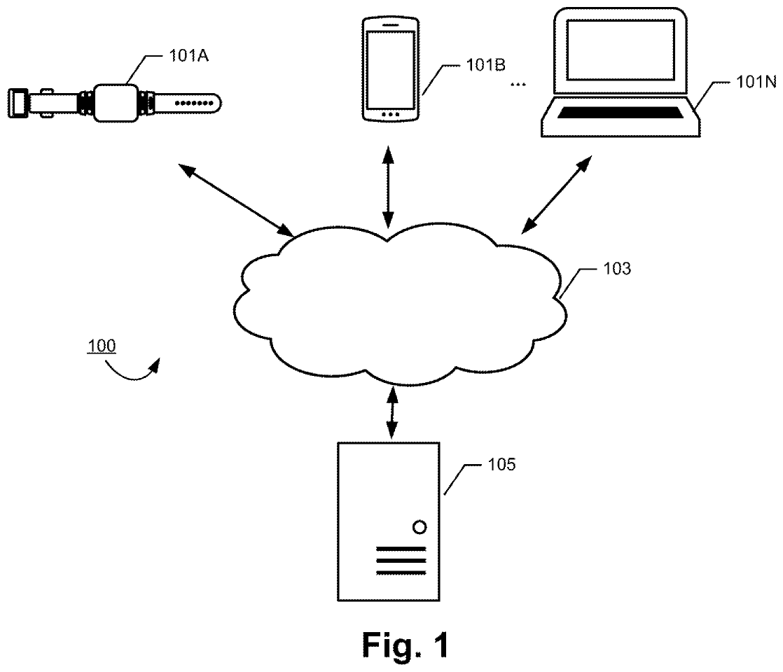

FIG. 1 provides an illustration of a multi-measure optimized ranking generation platform/system 100 that can be used in conjunction with various embodiments of the present disclosure. As shown in FIG. 1, the multi-measure optimized ranking generation platform/system 100 may comprise apparatuses, devices, and components such as, but not limited to, one or more client computing entities 101A . . . 101N, one or more ranking generation computing entities 105 and one or more networks 103.

Each of the components of the multi-measure optimized ranking generation platform/system 100 may be in electronic communication with, for example, one another over the same or different wireless or wired networks 103 including, for example, a wired or wireless Personal Area Network (PAN), Local Area Network (LAN), Metropolitan Area Network (MAN), Wide Area Network (WAN), and/or the like. For example, the one or more client computing entities 101A . . . 101N and the one or more ranking generation computing entities 105 may be in electronic communication with one another to exchange data and information. Additionally, while FIG. 1 illustrates certain system entities as separate, standalone entities, the various embodiments are not limited to this particular architecture.

a. Exemplary Ranking Generation Computing Entity

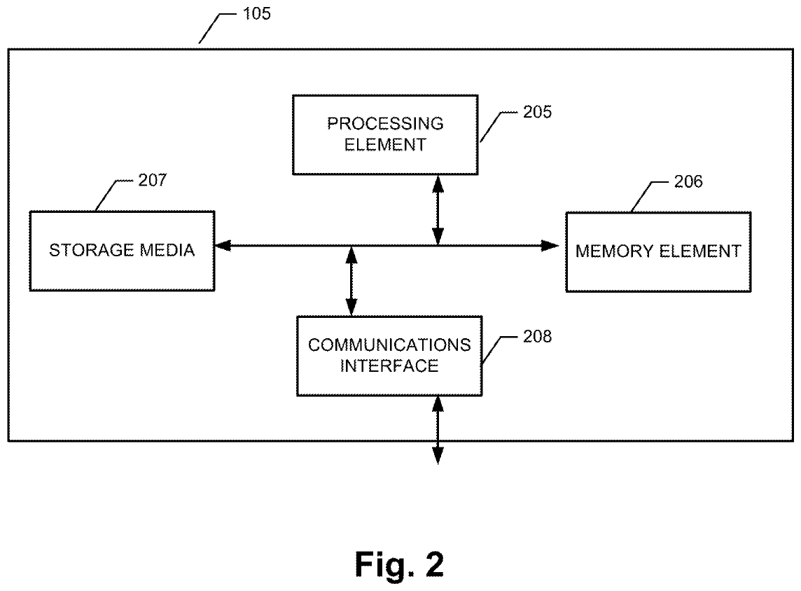

FIG. 2 provides a schematic of a ranking generation computing entity 105 according to one embodiment of the present disclosure. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein.

As indicated, in one embodiment, the ranking generation computing entity 105 may also include one or more network and/or communications interface 208 for communicating with various computing entities, such as by communicating data, content, information, and/or similar terms used herein that can be transmitted, received, operated on, processed, displayed, stored, and/or the like. For instance, the ranking generation computing entity 105 may communicate with other ranking generation computing entities 105, one or more client computing entities 101A-101N, and/or the like.

As shown in FIG. 2, in one embodiment, the ranking generation computing entity 105 may include or be in communication with one or more processing elements (for example, processing element 205) (also referred to as processors, processing circuitry, and/or similar terms used herein interchangeably) that communicate with other elements within the ranking generation computing entity 105 via a bus, for example, or network connection. As will be understood, the processing element 205 may be embodied in a number of different ways. For example, the processing element 205 may be embodied as one or more complex programmable logic devices (CPLDs), microprocessors, multi-core processors, co-processing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

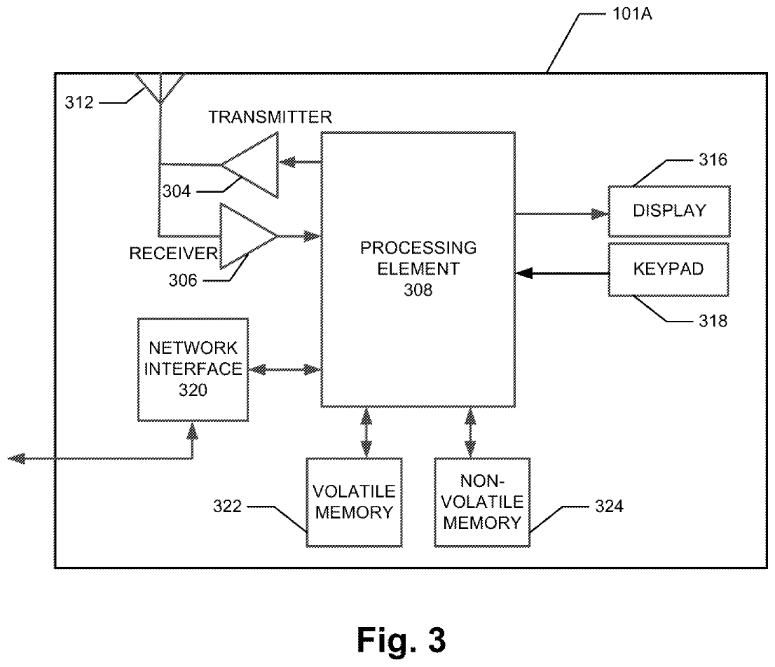

In one embodiment, the ranking generation computing entity 105 may further include or be in communication with volatile media (also referred to as volatile storage, memory, memory storage, memory circuitry and/or similar terms used herein interchangeably). In one embodiment, the volatile storage or memory may also include one or more memory element 206 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory element 206 may be used to store at least portions of the databases, database instances, database management system entities, data, applications, programs, program modules, scripts, source code, object code, byte code, compiled code, interpreted code, machine code, executable instructions, and/or the like being executed by, for example, the processing element 205 as shown in FIG. 2 and/or the processing element 308 as described in connection with FIG. 3. Thus, the databases, database instances, database management system entities, data, applications, programs, program modules, scripts, source code, object code, byte code, compiled code, interpreted code, machine code, executable instructions, and/or the like may be used to control certain aspects of the operation of the ranking generation computing entity 105 with the assistance of the processing element 205 and operating system.

In one embodiment, the ranking generation computing entity 105 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or storage media 207 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or storage media 207 may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to may refer to a structured or unstructured collection of information/data that is stored in a computer-readable storage medium.

Storage media 207 may also be embodied as a data storage device or devices, as a separate database server or servers, or as a combination of data storage devices and separate database servers. Further, in some embodiments, storage media 207 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. An example of the embodiments contemplated herein would include a cloud data storage system maintained by a third-party provider and where some or all of the information/data required for the operation of the recovery system may be stored. Further, the information/data required for the operation of the recovery system may also be partially stored in the cloud data storage system and partially stored in a locally maintained data storage system. More specifically, storage media 207 may encompass one or more data stores configured to store information/data usable in certain embodiments.

As indicated, in one embodiment, the ranking generation computing entity 105 may also include one or more network and/or communications interface 208 for communicating with various computing entities, such as by communicating data, content, information, and/or similar terms used herein interchangeably that can be transmitted, received, operated on, processed, displayed, stored, and/or the like. For instance, the ranking generation computing entity 105 may communicate with computing entities or communication interfaces of other ranking generation computing entities 105, client computing entities 101A-101N, and/or the like.

As indicated, in one embodiment, the ranking generation computing entity 105 may also include one or more network and/or communications interface 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOC SIS), or any other wired transmission protocol. Similarly, the ranking generation computing entity 105 may be configured to communicate via wireless external communication networks using any of a variety of protocols, such as general packet radio service (GPRS), Universal Mobile Telecommunications System (UMTS), Code Division Multiple Access 1900 (CDMA1900), CDMA1900 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), Institute of Electrical and Electronics Engineers (IEEE) 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The ranking generation computing entity 105 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the ranking generation computing entity's components may be located remotely from components of other ranking generation computing entities 105, such as in a distributed system. Furthermore, one or more of the components may be aggregated and additional components performing functions described herein may be included in the ranking generation computing entity 105. Thus, the ranking generation computing entity 105 can be adapted to accommodate a variety of needs and circumstances.

b. Exemplary Client Computing Entity

FIG. 3 provides an illustrative schematic representative of one of the client computing entities 101A to 101N that can be used in conjunction with embodiments of the present disclosure. As will be recognized, the client computing entity may be operated by an agent and include components and features similar to those described in conjunction with the ranking generation computing entity 105. Further, as shown in FIG. 3, the client computing entity may include additional components and features. For example, the client computing entity 101A can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as a ranking generation computing entity 105, another client computing entity 101A, and/or the like. In this regard, the client computing entity 101A may be capable of operating with one or more air interface standards, communication protocols, modulation types, and access types. More particularly, the client computing entity 101A may comprise a network interface 320, and may operate in accordance with any of a number of wireless communication standards and protocols. In a particular embodiment, the client computing entity 101A may operate in accordance with multiple wireless communication standards and protocols, such as GPRS, UMTS, CDMA1900, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the client computing entity 101A can communicate with various other entities using Unstructured Supplementary Service data (USSD), Short Message Service (SMS), Multimedia Messaging Service (MMS), Dual-Tone Multi-Frequency (DTMF) Signaling, Subscriber Identity Module Dialer (SIM dialer), and/or the like. The client computing entity 101A can also download changes, add-ons, and updates, for instance, to its firmware, software (e.g., including executable instructions, applications, program modules), and operating system.

According to one embodiment, the client computing entity 101A may include location determining aspects, devices, modules, functionalities, and/or similar words used herein interchangeably. For example, the client computing entity 101A may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information/data/data may be determined by triangulating the position in connection with a variety of other systems, including cellular towers, Wi-Fi access points, and/or the like. Similarly, the client computing entity 101A may include indoor positioning aspects, such as a location module adapted to acquire, for example, latitude, longitude, altitude, geocode, course, direction, heading, speed, time, date, and/or various other information/data. Some of the indoor aspects may use various position or location technologies including Radio-Frequency Identification (RFID) tags, indoor beacons or transmitters, Wi-Fi access points, cellular towers, nearby computing devices (e.g., smartphones, laptops) and/or the like. For instance, such technologies may include iBeacons, Gimbal proximity beacons, Bluetooth Low Energy (BLE) transmitters, Near Field Communication (NFC) transmitters, and/or the like. These indoor positioning aspects can be used in a variety of settings to determine the location of someone or something to within inches or centimeters.

The client computing entity 101A may also comprise a user interface comprising one or more user input/output interfaces (e.g., a display 316 and/or speaker/speaker driver coupled to a processing element 308 and a touch screen, keyboard, mouse, and/or microphone coupled to a processing element 308). For example, the user output interface may be configured to provide an application, browser, user interface, dashboard, webpage, and/or similar words used herein interchangeably executing on and/or accessible via the client computing entity 101A to cause display or audible presentation of information/data and for user interaction therewith via one or more user input interfaces. The user output interface may be updated dynamically from communication with the ranking generation computing entity 105. The user input interface can comprise any of a number of devices allowing the client computing entity 101A to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the client computing entity 101A and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the client computing entity 101A can collect information/data, user interaction/input, and/or the like.

The client computing entity 101A can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the client computing entities 101A-101N.

c. Exemplary Networks

In one embodiment, the networks 103 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 103 may have any suitable communication range associated therewith and may include, for example, global networks (e.g., the Internet), MANs, WANs, LANs, or PANs. In addition, the networks 103 may include medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms/systems provided by network providers or other entities.

Further, the networks 103 may utilize a variety of networking protocols including, but not limited to, TCP/IP based networking protocols. In some embodiments, the protocol is a custom protocol of JavaScript Object Notation (JSON) objects sent via a WebSocket channel. In some embodiments, the protocol is JSON over RPC, JSON over REST/HTTP, and/or the like.

### III. EXEMPLARY OPERATION

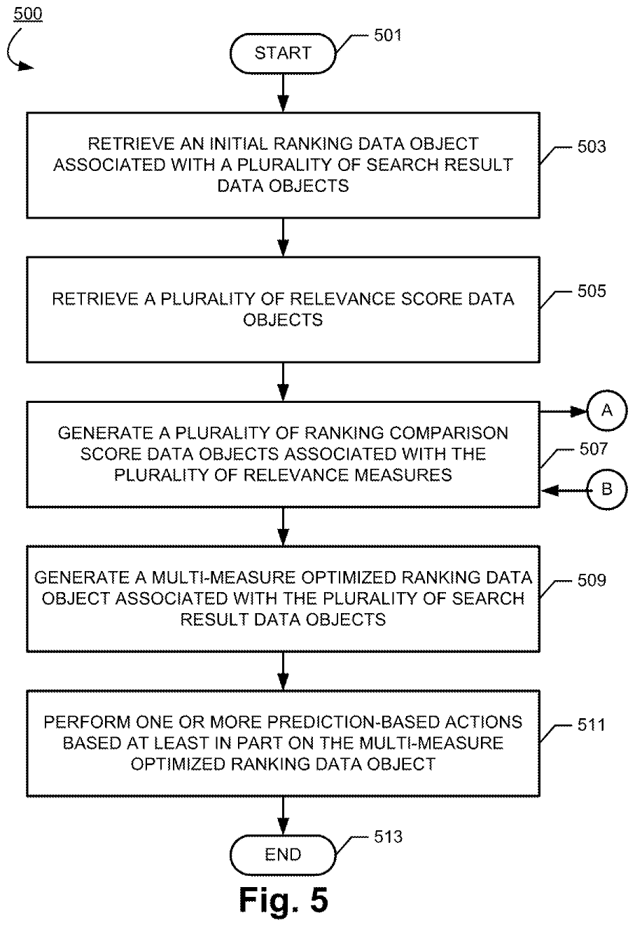

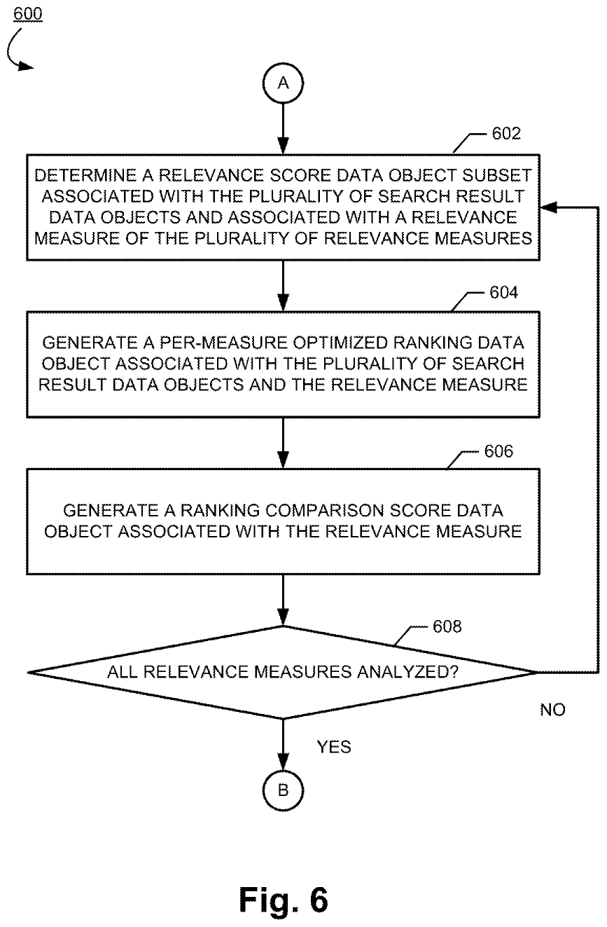

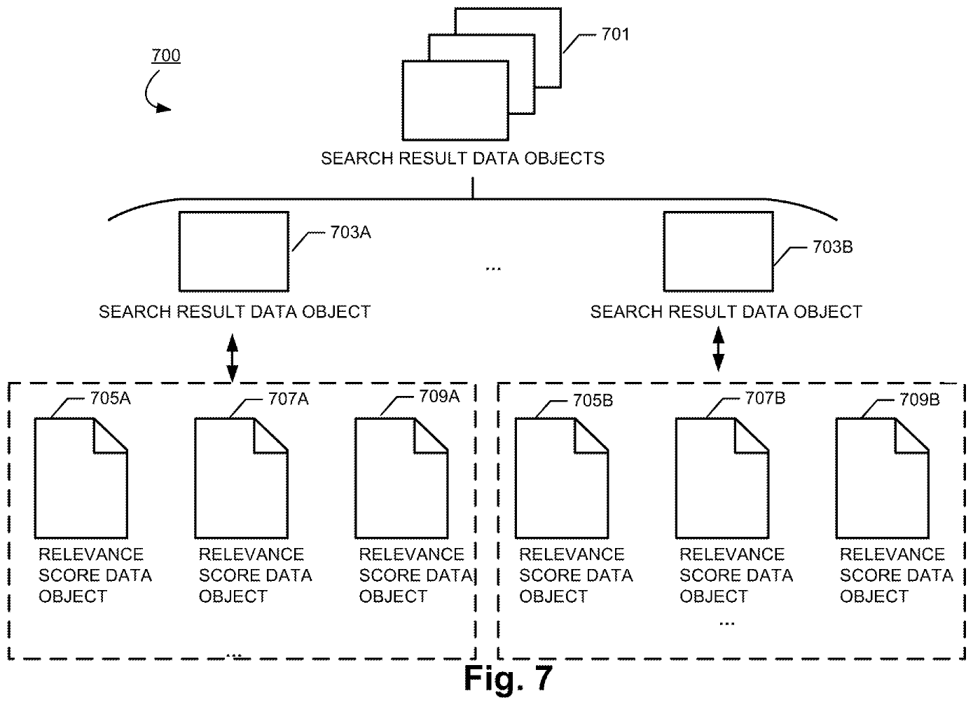

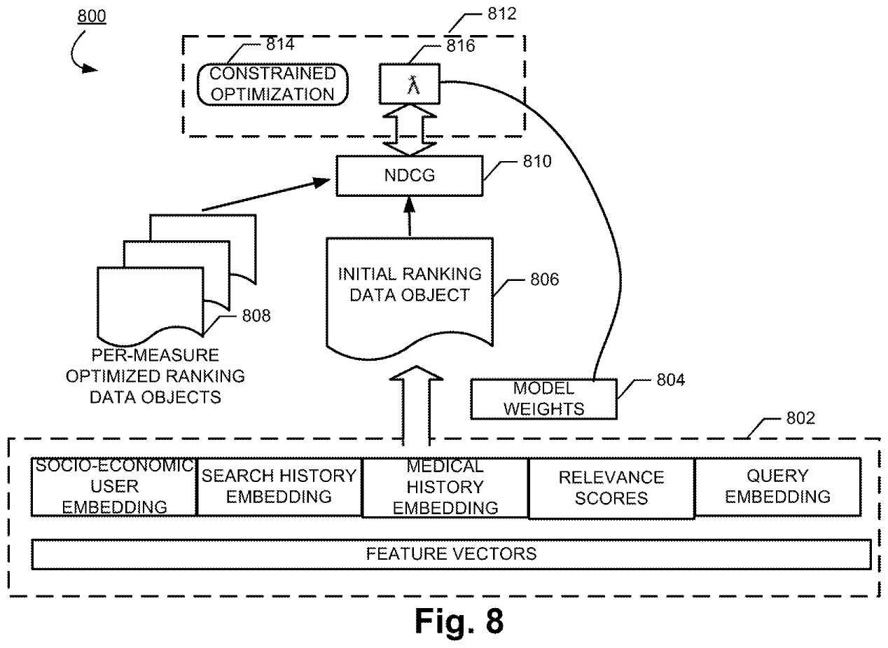

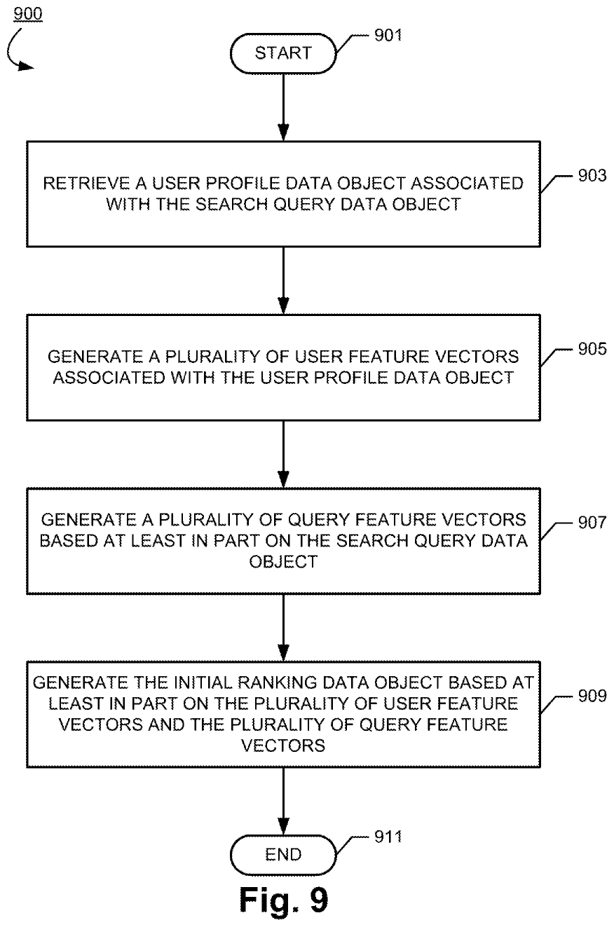

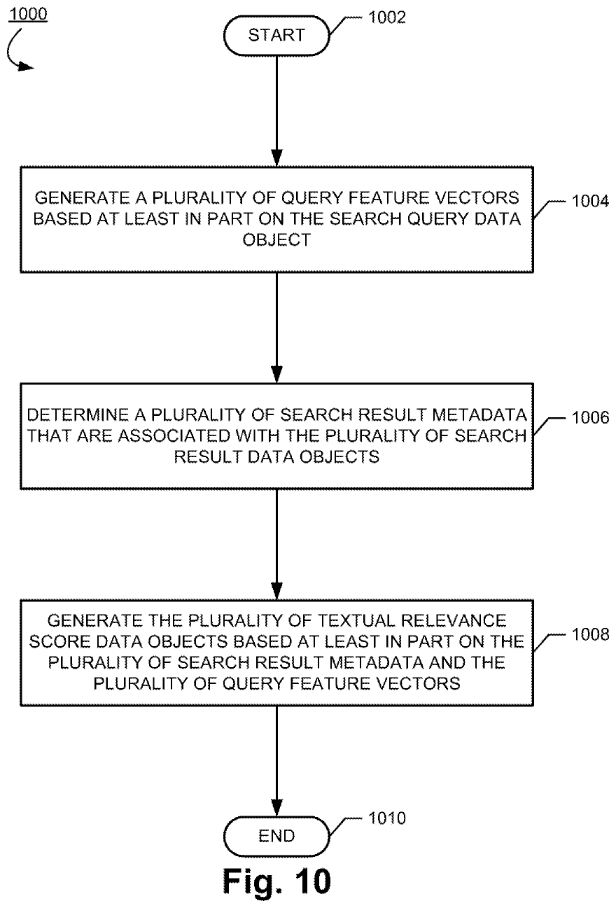

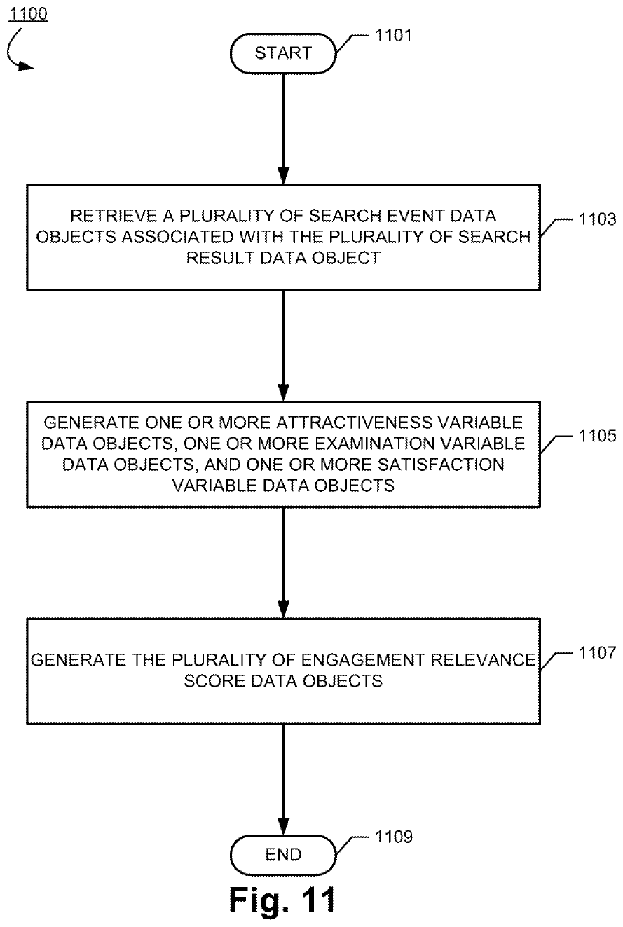

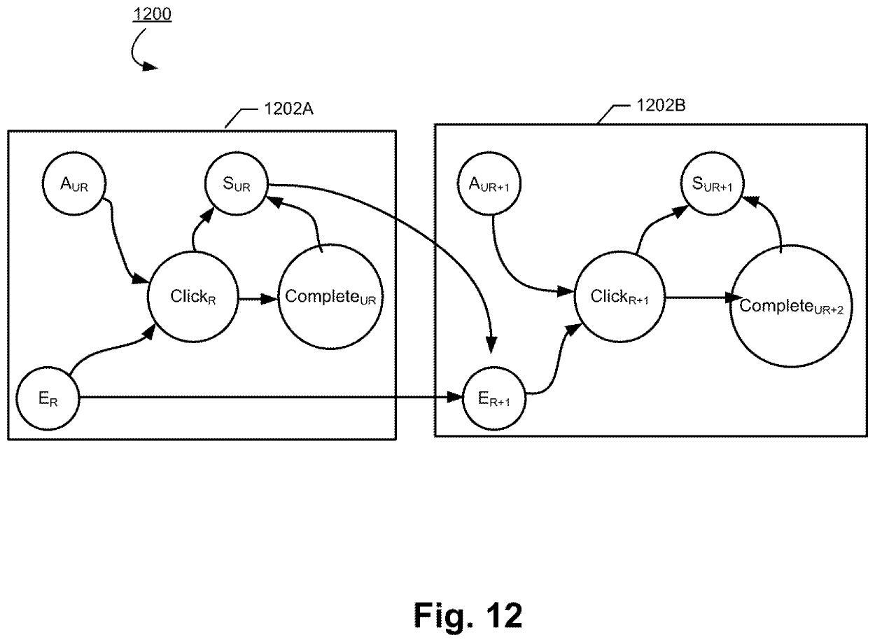

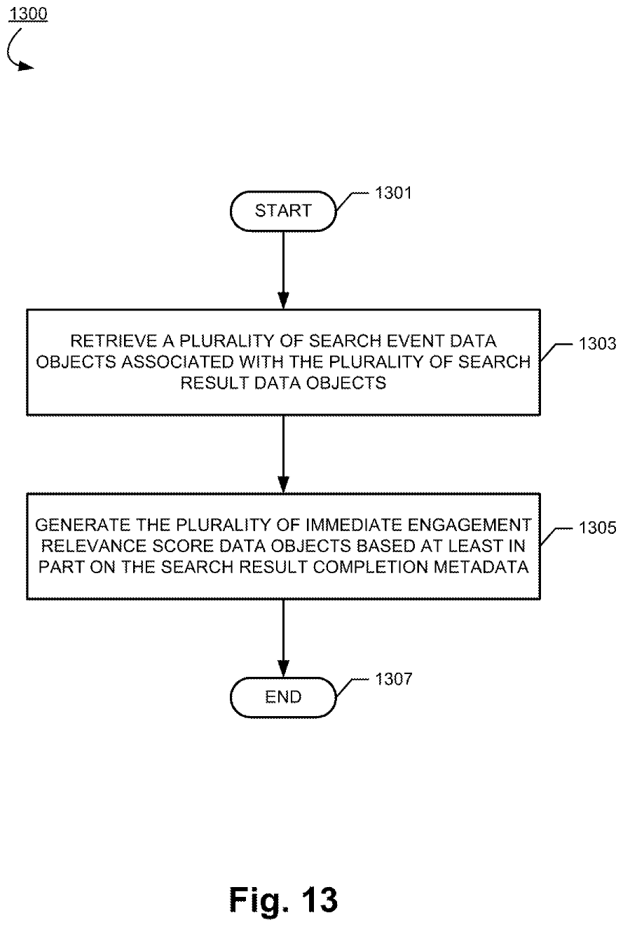

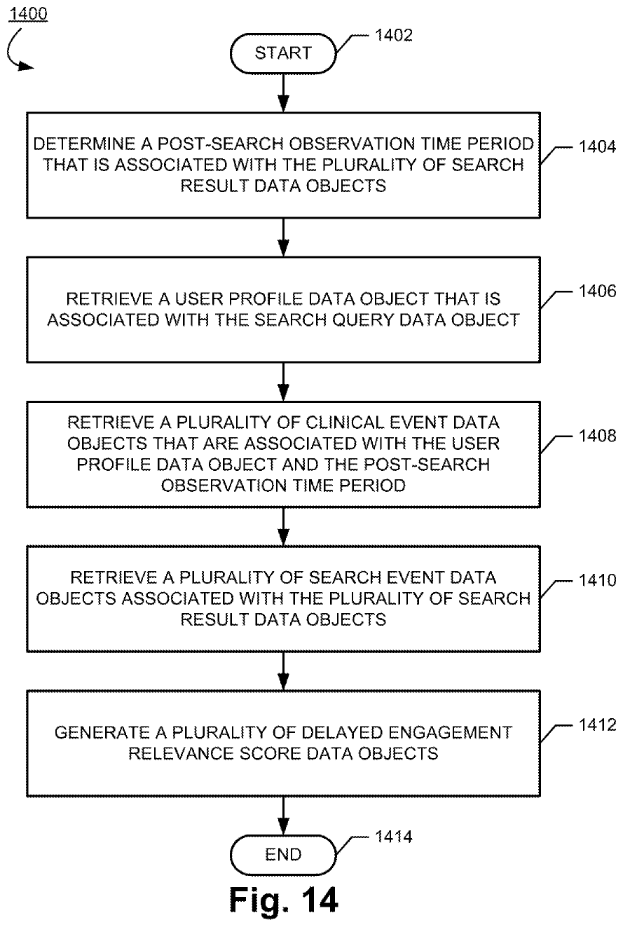

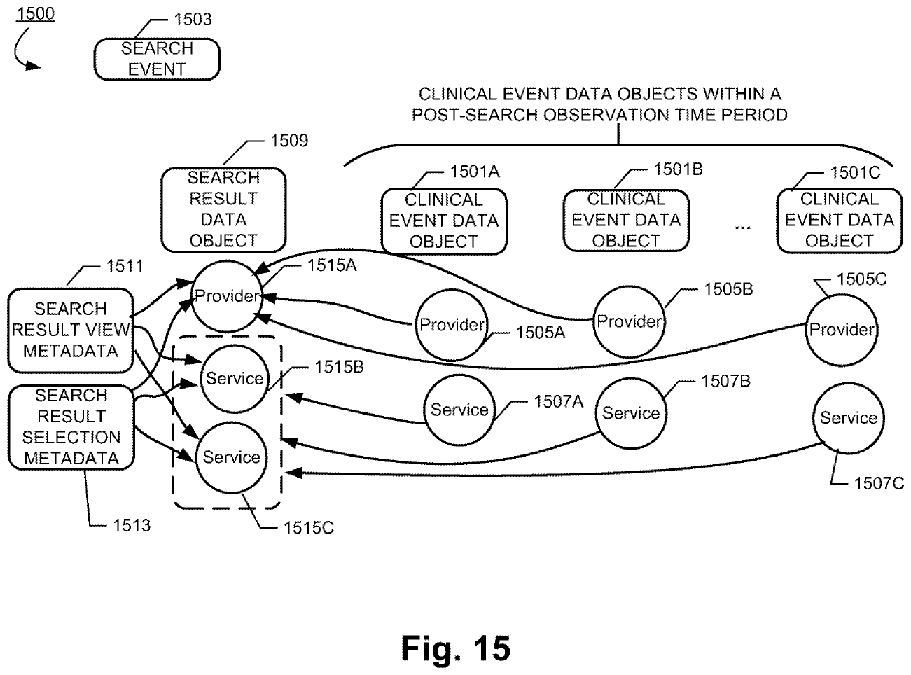

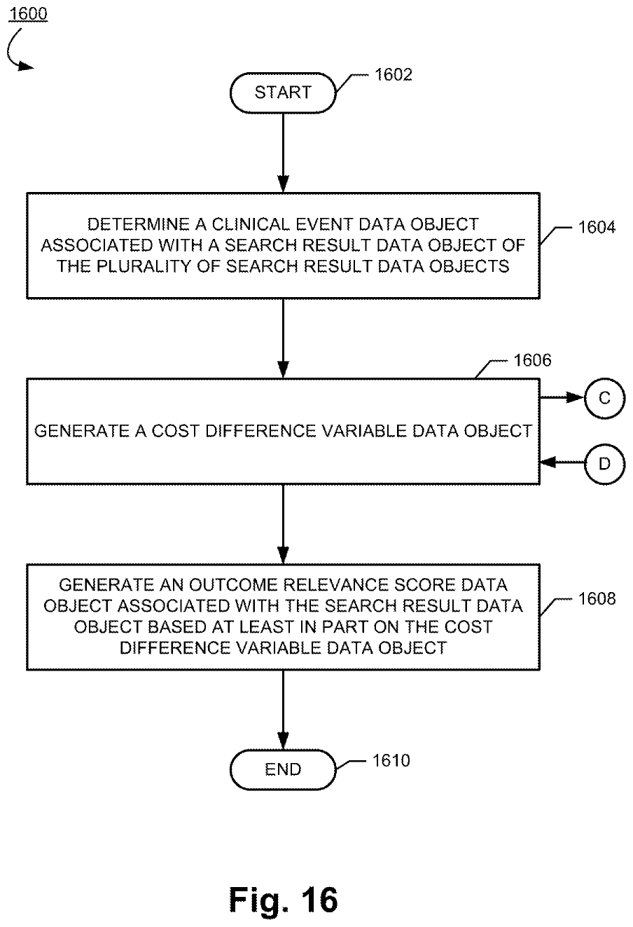

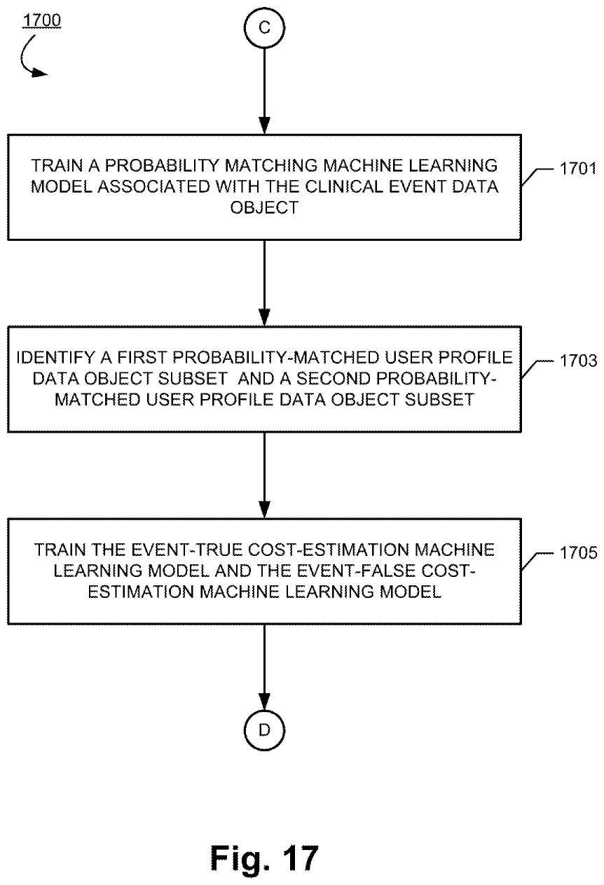

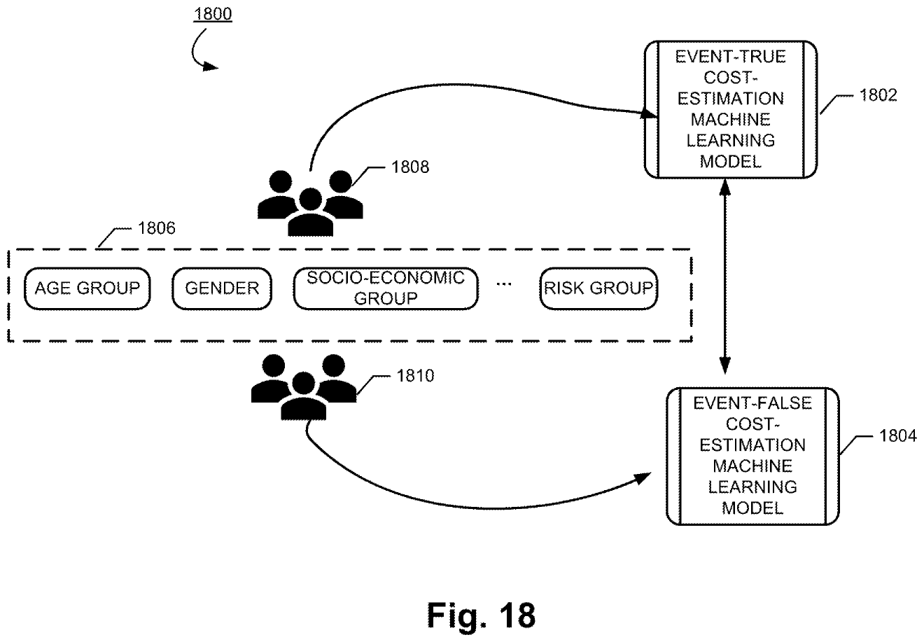

Reference will now be made to FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, and FIG. 18, which provide flowcharts and diagrams illustrating example steps, processes, procedures, and/or operations associated with an example multi-measure optimized ranking generation platform/system and/or an example ranking generation computing entity in accordance with various embodiments of the present disclosure.

It is noted that each block of the flowchart, and combinations of blocks in the flowchart, may be implemented by various means such as hardware, firmware, circuitry and/or other devices associated with execution of software including one or more computer program instructions. For example, one or more of the methods described in FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, and FIG. 18 may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based at least in part on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

While example embodiments of the present disclosure may be described in the context of healthcare, a person of ordinary skill in the relevant technology will recognize that embodiments of the present disclosure are not limited to this context only.

a. Overview and Technical Advantages

Various embodiments of the present invention provide machine learning solutions for improving search accuracy in a search platform that is configured to generate search results for search queries that enables gathering insights from multiple ranking mechanisms into a multi-measure optimized ranking data object that provides comprehensive search result. This leads to a search platform that can generate accurate search results even when underlying search queries fail to contain a large number of semantic inferences. In this way, various embodiments of the present invention reduce the need for end-users of search platforms to do repeated search operations with more precise search queries, which in turn reduces the overall number of search queries transmitted to a search platform and hence the operational load of the search platform. In this way, by reducing the operational load on search platforms, various embodiments of the present invention improve operational reliability and computational efficiency of search platforms.

As described above, there are many technical challenges and difficulties associated with search engines and search algorithms, especially when such search engines and search algorithms are implemented in complex enterprise computing environments.

As an example, many users input search queries to search engines that are provided by enterprises in the healthcare industry in order to obtain healthcare related information such as, but not limited to, healthcare provider information (e.g., information related to medical care or treatment offered healthcare providers, information related to physicians' and health care professionals' credentials and specialties, and/or the like), healthcare programs and activities (e.g., health coaching programs, classes or seminars on health topics, and/or the like), pharmaceutical and medication-related information (e.g. uses and side effects of medications, cost of medications, and/or the like), and health insurance information (e.g. summary of coverage associated with health insurances, deductibles and out-of-pocket maximum associated with health insurances, and/or the like). Due to the complex nature of healthcare related information, many search engines fail to provide search results that are relevant to the user and relevant to the search query.

For example, search results generated by many search engines are not personalized based at least in part on the user who input the search query. In other words, many search engines may generate the same search results to the same search query submitted by different users. While some users may find these search results to be relevant, other users may not find these search results to be relevant.

Continuing from the healthcare industry example above, when a user inputs a search query “primary care physician” to the search engine, the search engine may generate search results that provides information related to primary care physicians such as, but not limited to, family practice physicians, internal medicine physicians, general practice physicians, pediatricians, and/or the like. However, different users may find the same information to have different levels of relevance. For example, users with chronic health conditions may find information related to internal medicine physicians to be more relevant than information related to pediatricians, while users who are looking for primary care physicians for children may find information related to pediatricians to be more relevant than information related to internal medicine physicians.

As another example, many search engines do not perform semantic matching when generating and/or ranking search results, and users of such search engines cannot obtain all the relevant search results. Semantic matching may refer to a data retrieval technique that identifies information which is semantically related to the search query. Without semantic matching, many search engines rely on keywords to generate search results and/or determine the relevance of these search results.

Continuing from the healthcare industry example above, a user may input a search query “temazepam” to the search engine to retrieve relevant information from a database provided by a healthcare enterprise. Temazepam is a medication that is often prescribed to treat certain sleep problems (e.g., insomnia), and therefore is semantically related to insomnia treatment. If “temazepam” has not been configured as a keyword in search engines that rely on keywords, such search engines may determine that there are no relevant search results for this search query, even if there is information for insomnia treatment in the database. The lack of semantic matching causes lower recall, which may refer to the ability of a search engine to find the relevant information. One study has shown that 34% of free text searches to a search engine yield no results.

As another example, many search engines rank search results solely on the basis of one-dimensional relevance (for example, user proximity, syntactic matching, or keyword configuration), and do not consider the value of information and/or recommendations provided by the search results (for example, but not limited to, index to measure positive health outcome, affordability, cost savings, user engagement and provider/program popularity).

Continuing from the healthcare industry example above, a user may input a search query “medical test” to the search engine provided by a healthcare enterprise in order to obtain information related to medical tests. Some search engines rank the search results based at least in part on user proximity (for example, based at least in part on the proximity between the location of the user and the location of the healthcare facility that offers medical tests). Some search engines rank the search results based at least in part on syntactic matching (for example, based at least in part on syntactic similarities between “medical test” and the descriptions of services offered by healthcare facilities) or keyword configuration (for example, based at least in part on determining whether the descriptions of services offered by healthcare facilities include the keyword “medical test”). Some search engines rank the search results based at least in part on the click-through-rates (for example, based at least in part on whether the user is likely to click or select the search results) or sales/gross profit (for example, based at least in part on costs or profit margins of medical tests offered by healthcare facilities). However, healthcare search is complex and different from simple web search and e-commerce search, as objectives of healthcare search cannot be boiled down to a single metric such as increasing the number of items sold or increasing the number of advertisements clicked. Because of the complex nature of healthcare search, search engines and search algorithms should provide optimized search results and search result rankings based at least in part on multiple measures such as, but not limited, improving user's health in addition to relevance to the query and affordability for the user.

The description above provides some examples of technical challenges and difficulties in the realm of computer technologies, especially related to data retrievals from network databases. Various embodiments of the present discourse overcome such technical challenges and difficulties, and provide various technical advantages and improvements.

For example, various embodiments of present disclosure describe example methods, apparatuses, and computer program products that not only provide search result data objects that are personalized based at least in part on the user profile data object associated with the search query data object, but also provide multi-measure optimized ranking data objects of the search result data objects.

For example, various embodiments of present disclosure generate personalized search result data objects that are personalized based at least in part on feature vectors representing user demographics, user search history, user clinical history, and/or the like. By providing personalized search result data objects, various embodiments of the present disclosure improve precision in generating relevant search results, and therefore providing technical benefits and improvements in data retrieval from network computer database systems.

In some embodiments, various embodiments of present disclosure generate multi-measure optimized ranking data objects that provide optimized rankings of search result data objects for multiple objectives simultaneously within the search experience. For example, the multi-measure optimized ranking data objects optimize for multiple relevance measures (as measured by normalized discounted cumulative gains (“NDCG”)), and such relevance measures are related to not only user engagement and preference, but also affordability and health activation index (HAI). In some embodiments, such relevance measures make up the sub-objectives of a multi-objective ranking optimization (MORO) framework for generating multi-measure optimized ranking data objects.

For example, HAI provides a way to predict and quantify healthcare outcome impacts based at least in part on healthcare economic data. HAI assigns quantitative values to health actions such as, but not limited to, mammogram completion, flu shot, closures of various gaps in care, program enrollments, biometric screenings, and more.

As another example, various embodiments of the present disclosure quantify healthcare affordability to indicate the extent to which a search engine is driving users to more cost effective providers, procedures, and sites of care. In particular, various embodiments of the present disclosure generate cost difference variable data objects that indicate an inferred medical cost saving of each clinical event of interest from the search result data objects. For example, various embodiments of the present disclosure apply two regression models to predict future medical expenses of matched populations as a measure of affordability to a user, improving the relevance in generating relevant search results for the user and providing technical benefits and improvements in data retrieval from network computer database systems.

As another example, various embodiments of the present disclosure utilities NDCG of ranking by semantic relevance as the primary objective in generating multi-measure optimized ranking data objects. Various embodiments of the present discourse also generate delayed engagement relevance score data objects that attribute delayed clinical events to the search events by syntactically and semantically matching clinical metadata with the search item metadata. As such, various embodiments of the present disclosure improve the relevance of search results based at least in part on user engagement and provide technical benefits and improvements in data retrieval from network computer database systems.

Various embodiments of the present disclosure implements a search ranking function that optimizes for potential to improve patient health outcome using HAI, affordability and semantic relevance/user engagement. In particular, various embodiments of the present disclosure integrate feature vectors representing user demographics, user search and clinical history, and the like into a multi-objective ranking optimization (MORO) framework and define objective functions that optimize the ranking of diverse search results based at least in part on NDCG, affordability, and HAI simultaneously, with constraints applied to each sub-objective. As such, various embodiments of the present disclosure generate multi-measure optimized ranking data objects that simultaneously optimize query textual relevance, user engagement and clinical outcome, providing technical benefits and advantages on data retrieval from network databases such as, but not limited to, improving precision and recall of search results data objects, reducing the computing resource consumption in generating and ranking search results, and improving user experience in interacting with network databases, details of which are described herein.

b. Definitions

In the present disclosure, the term “data object” may refer to a data structure that represents, indicates, stores and/or comprises data and/or information. In some embodiments, a data object may be in the form of one or more regions in one or more data storage devices (such as, but not limited to, a computer-readable storage medium) that comprise one or more values (such as, but not limited to, one or more identifiers, one or more metadata, and/or the like). In some embodiments, an example data object may comprise or be associated with one or more identifiers, one or more metadata, and/or one or more other data objects.

In accordance with various embodiments of the present disclosure, data objects may be characterized based at least in part on structure or format that data and/or information are organized in the data objects.

In the present disclosure, the term “search query data object” may refer to a type of data object that comprises data and/or information associated with a search query. In some embodiments, the search query indicates a data retrieval request from the user to retrieve data and/or information from a network database. In some embodiments, the search query may comprise plain text, and the search query data object comprises the plain text from the search query. In some embodiments, the search query data object may be in the form of text string(s), numerical character(s), alphabetical character(s), alphanumeric code(s), American Standard Code for Information Interchange (ASCII) character(s), a pointer, a memory address, and/or the like.

In the present disclosure, the term “feature vector” may refer to a type of vector that represents numerical or symbolic characteristics (also referred to as “features”) associated with data and/or information. For example, an example feature vector may be in the form of an n-dimensional vector of numerical or symbolic features that describe one or more data objects (such as, but not limited to, search query data object, user profile data object (as defined herein)). In some embodiments, one or more feature vectors are provided to machine learning models. Examples of machine learning models are described herein.

In the present disclosure, the term “query feature vector” may refer to a type of feature vector that is associated with a search query data object. For example, an example query feature vector may be in the form of an n-dimensional vector of numerical or symbolic features that describe an example search query data object. In various embodiments of the present disclosure, an example query feature vector is associated with an example query feature vector type. For example, example query feature vectors comprise one or more of query embedding vectors and query-item relevance vectors.

In the present disclosure, the term “query embedding vector” may refer to a type of query feature vector that is associated with syntactic and/or semantic characteristics of a search query data object. For example, an example query embedding vector may be in the form of an n-dimensional vector of syntactic and/or semantic features of an example search query data object.

In some embodiments, an example query embedding vector is generated from syntactic representation(s) and/or semantic representation(s). In some embodiments, syntactic representations are generated based at least in part on techniques such as, but not limited to, frequency-inverse document frequency (TF-IDF) and/or the like. In some embodiments, semantic representations are generated based at least in part on, for example but not limited to, providing the search query data object to a machine learning model such as, but not limited to, a deep learning model (e.g. Bidirectional Encoder Representations from Transformers (BERT), etc.).

In the present disclosure, the term “query-item relevance vector” may refer to a type of query feature vector that indicates one or more relevance representations between a search query data object and one or more search result data objects (as defined herein). For example, an example query-item relevance vector may be in the form of an n-dimensional vector of relevance scores associated with the search query data object and one or more search result data objects. In some embodiments, the relevance scores may be generated based at least in part on calculating cosine similarities between the query embedding vectors and the search result metadata (as defined herein).

In the present disclosure, the term “search result data object” may refer to a type of data object that comprises data and/or information associated with a search result in response to a search query. In some embodiments, a computing entity (e.g. a network server) generates a search result data object in response to a search query data object from a user. As described above, the search query data object indicates a data retrieval request from the user to retrieve data and/or information from a network database. Based at least in part on the data retrieval request, the computing entity (e.g. the network server) retrieves data and/or information from the network database, and generates the search result data object that represents the retrieved data and/or information. In some embodiments, the search result data object may be in the form of text string(s), numerical character(s), alphabetical character(s), alphanumeric code(s), ASCII character(s), a pointer, a memory address, and/or the like.

In the present disclosure, the term “metadata” may refer to a set of data that describes and/or provides data and/or information associated with a data object. In some embodiments, example metadata may be in the form of a parameter, a data field, a data element, or the like that describes an attribute of a data object.

In the present disclosure, the term “search result metadata” may refer to metadata associated with a search result data object. For example, the search result metadata may comprise text string(s), numerical character(s), alphabetical character(s), alphanumeric code(s), ASCII character(s), and/or the like that describe the content of the search result associated with the search result data object.

For example, an example search query data object may describe a search query for healthcare provider information, and an example search result data object generated in response to the search query data object may comprise information such as, but not limited to, healthcare provider name, services offered by the healthcare provider, and/or the like. In such an example, the search result metadata may comprise one or more text strings that correspond to the healthcare provider name and one or more text strings that correspond to the healthcare service name.

In the present disclosure, the term “search event data object” may refer to a type of data object that comprises data and/or information associated with user engagement and/or interactions associated with one or more search result data objects. For example, an example search result data object may be rendered on a display of a client computing entity. In such an example, the user may view the search result data object and/or click, tap, or otherwise select the search result data object. In some embodiments, an example search event data object associated with an example search query data object may comprise data and/or information indicating whether the user has viewed the search query data object and/or whether the user has clicked, tapped, or otherwise selected the search query data object. In some embodiments, the search event data object may be in the form of text string(s), numerical character(s), alphabetical character(s), alphanumeric code(s), ASCII character(s), a pointer, a memory address, and/or the like. While the description above provides examples of search event data objects, it is noted that the scope of the present disclosure is not limited to the description above. In some examples, the search event data object may comprise data and/or information associated with other type(s) of user interaction(s) associated with the search result data object.

In some embodiments, an example search event data object may comprise search event metadata such as, but not limited to, search result view metadata, search result selection metadata, and search result completion metadata.

In the present disclosure, the term “search result view metadata” may refer to metadata associated with a search result data object that indicates whether a user has viewed one or more search result data objects. For example, the one or more search result data objects may be rendered on a display of a client computing entity, and the search result view metadata may indicate whether a user associated with a user profile data object has viewed each of the one or more search result data objects based at least in part on, for example, whether the user has scrolled through the one or more search result data objects.

In the present disclosure, the term “search result selection metadata” may refer to metadata associated with a search result data object that indicates whether a user has selected the search result data object (for example, whether the user has clicked on the search result data object). For example, the one or more search result data objects may be rendered on a display of a client computing entity, and the search result selection metadata may indicate whether a user associated with a user profile data object has clicked on or otherwise selected each of the one or more search result data objects.

In the present disclosure, the term “search result completion metadata” may refer to metadata associated with a search result data object that indicates whether a user has engaged, interacted with, completed one or more activities associated with the search result corresponding to the search result data object (for example, directly via the client computing entity). For example, if the search result described by the search result data object requires enrollment or sign-ups, the search result completion metadata indicates whether the user completed the enrollment or sign-ups via the client computing entity immediately or soon after the user received the search result data object.

While the description above provides examples of metadata associated with a search event data object that comprise search result view metadata, search result selection metadata, and search result completion metadata, it is noted that the scope of the present disclosure is not limited to the description above. In some examples, an example search event data object may comprise one or more additional and/or alternative types of metadata.

In the present disclosure, the term “attractiveness variable data object” may refer to a type of data object that indicates an attractiveness level of a search result data object to a user associated with a user profile data object. In some embodiments, the attractiveness level can be calculated based at least in part on the search result selection metadata associated with the search event data object.

In some embodiments, the attractiveness variable data object is in the form of a binary variable (A t). For example, the value of the attractiveness variable data object equals one (1) if a user associated with the user profile data object clicks on or selects the search result data object i, and the value of the attractiveness variable data object equals zero (0) if a user associated with the user profile data object does not click on or select the search result data object i.

Additionally, or alternatively, the attractiveness variable data object may be in the form of text string(s), numerical character(s), alphabetical character(s), alphanumeric code(s), ASCII character(s), a pointer, a memory address, and/or the like.

In the present disclosure, the term “examination variable data object” may refer to a type of data object that indicates an examination level of a search result data object by a user associated with a user profile data object. In some embodiments, the examination level can be calculated based at least in part on the search result selection metadata associated with the search event data objects.

In some embodiments, the examination variable data object is in the form of a binary variable (Eᵢ). For example, a plurality of search result data objects may be rendered on a display of a client computing entity according to an initial ranking data object (or as ranked based at least in part on the textual relevance score data objects). In such an example, the value of the examination variable data object equals one (1) if the search result data object i is the last search result data object that is clicked or selected by the user associated with the user profile data object from a list of search result data objects (according to the initial ranking data object or as ranked based at least in part on the textual relevance score data objects), or if the search result data object i is listed above the last search result data object that is clicked or selected by the user associated with the user profile data object. The value of the examination variable data object equals zero (0) if the search result data object i is listed below the last search result data object that is last clicked or selected by the user associated with the user profile data object in the list of search result data objects according to the initial ranking data object or as ranked based at least in part on the textual relevance score data objects.

Additionally, or alternatively, the examination variable data object may be in the form of text string(s), numerical character(s), alphabetical character(s), alphanumeric code(s), ASCII character(s), a pointer, a memory address, and/or the like.

In the present disclosure, the term “satisfaction variable data object” may refer to a type of data object that indicates a satisfaction level of a search result data object according to a user associated with a user profile data object. In some embodiments, the satisfaction level can be calculated based at least in part on the search result selection metadata associated with the search event data objects.

In some embodiments, the satisfaction variable data object is in the form of a binary variable (Sᵢ). For example, a plurality of search result data objects may be rendered on a display of a client computing entity according to an initial ranking data object (as defined herein). In such an example, the value of the satisfaction variable data object of a search result data object i equals one (1) if the search result data object i is the last search result data object that is clicked or selected by the user associated with the user profile data object. In addition, the last search result data object is counted if (a) the user does not press the back button on the user interface to return to previous renderings of previous search result data objects after viewing the search result data object and (b) the user does not submit a new search query within a time window after viewing the rendering of the search result data objects (for example but not limited to, within the next 15 minutes after viewing the rendering of the search result data objects). If the search result data object i is not the last search result data object that is last clicked or selected by the user associated with the user profile data object (e.g. if it does not satisfy both condition (a) and (b) above), the value of the satisfaction variable data object of a search result data object i equals zero (0).

Additionally, or alternatively, the satisfaction variable data object may be in the form of text string(s), numerical character(s), alphabetical character(s), alphanumeric code(s), ASCII character(s), a pointer, a memory address, and/or the like.

In the present disclosure, the term “user profile data object” may refer to a type of data object that comprises data and/or information associated with a user. For example, the user profile data object may comprise data and/or information that are associated with socio-economic status of the user, demographic information of the user, search history associated with the user, medical history associated with the user, and/or the like. In some embodiments, the user profile data object may be in the form of text string(s), numerical character(s), alphabetical character(s), alphanumeric code(s), ASCII character(s), a pointer, a memory address, and/or the like.

In the present disclosure, the term “user profile metadata” may refer to metadata associated with the user profile data object. For example, the user profile metadata may comprise text string(s), numerical character(s), alphabetical character(s), alphanumeric code(s), ASCII character(s), and/or the like that describe the content of the search result associated with the search result data object.

For example, the user profile metadata may comprise user socio-economic metadata, user demographics characteristics metadata, user search history metadata, user medical history metadata, and/or the like. In this example, the user socio-economic metadata describes social and economic factors associated with the user (for example, but not limited to, family income, education level, and/or the like). The user demographics characteristics metadata describes demographics characteristics associated with the user (for example, but not limited to, age, gender, household size, and/or the like). The user search history metadata describes the previous search query data objects associated with the user (for example, previous search queries that have been submitted by the user). The user medical history metadata describes medical history associated with the user (for example, medical claims that have been submitted by the user in the past).

In the present disclosure, the term “user feature vector” may refer to a type of feature vector that is associated with a user profile data object. For example, an example user feature vector may be in the form of an n-dimensional vector of numerical or symbolic features that describe an example user profile data object. In various embodiments of the present disclosure, an example user feature vector is associated with an example user feature vector type. For example, example user feature vectors comprise one or more of user socio-economics embedding vectors, user demographics characteristics vectors, user search history embedding vectors, and user medical history embedding vectors.

In the present disclosure, the term “user socio-economics embedding vector” may refer to a type of user feature vector that is associated with user socio-economics data of a user profile data object. For example, an example user socio-economics embedding vector may be in the form of an n-dimensional vector of user socio-economics data (for example, but not limited to, family income, education level, and/or the like) of an example user profile data object. In some embodiments, an example user socio-economics embedding vector is generated based at least in part on the user socio-economic metadata described above. For example, the user socio-economics embedding vector may be generated by providing the user socio-economic metadata to a 128 dimensional encoder layer. Additionally, or alternatively, the user socio-economics embedding vector may be generated by importing data of the social determinants of health (which is on the zip-code level), and training an auto-encoder modeling with a 128 dimensional encoder layer to produce the user socio-economics embedding vector.

In the present disclosure, the term “user demographics characteristics vector” may refer to a type of user feature vector that is associated with the user demographics characteristics data of a user profile data object. For example, an example user demographics characteristics vector may be in the form of an n-dimensional vector of demographics characteristics data (such as, but not limited to, age, gender, household size, membership tenure, etc.) of an example user profile data object. In some embodiments, an example user demographics characteristics vector is generated based at least in part on the user demographics characteristics metadata described above.

In the present disclosure, the term “user search history embedding vector” may refer to a type of user feature vector that is associated with the user search history information of a user profile data object, For example, an example user search history embedding vector may be in the form of an n-dimensional vector of user search history of an example user profile data object. In some embodiments, an example user search history embedding vector is generated based at least in part on the user search history metadata described above.

As an example, the user search history embedding vector may be generated based at least in part on identifying search query data objects associated with the user that have previously been submitted in a predetermined amount of days (for example, in the previous three days). A user search history embedding vector is generated to represent each of the search query data objects (e.g. by utilizing word2vec or other pre-trained deep learning models), and the query embedding vectors associated with these previously submitted search query data objects are aggregated over time by weighting these query embedding vectors (e.g. exponential weighting) to generate the user search history embedding vector.

In the present disclosure, the term “user medical history embedding vector” may refer to a type of user feature vector that is associated with the user medical history information of a user profile data object. For example, an example user medical history embedding vector may be in the form of an n-dimensional vector of user medical history data of an example user profile data object. In some embodiments, an example user medical history embedding vector is generated based at least in part on the user medical history metadata described above.

As an example, the user medical history embedding vector may be generated based at least in part on medical claim data associated with medical claims that the user has previously submitted in a predetermined amount of days (for example, in the previous three months). In this example, medical claim data contain code information such as, but not limited to, diagnosis codes and procedure codes. An embedding vector (e.g. from med2vec or other pre-trained deep learning models trained on claims data) is generated to represent each code information from the medical claim data, and these embedding vectors associated with the medical claim data is aggregated over time by weighting (e.g. exponential weighting) to generate the user medical history embedding vector.

In the present disclosure, the term “clinical event data object” may refer to a type of data object that comprises data and/or information associated with one or more clinical events that are related to healthcare (for example but not limited to, medical tests, visits to doctors, and/or the like).

In some embodiments, an example clinical event data object is related to a healthcare provider or a healthcare service. For example, an example clinical event may be in the form of a visit to a physician's office, a medical test by a medical laboratory, and/or the like.

In some embodiments, an example clinical event data object is associated with a user. In some embodiments, the clinical event data object is generated based at least in part on the electronic health records (EMRs) associated with the user.

In some embodiments, the clinical event data object may be in the form of text string(s), numerical character(s), alphabetical character(s), alphanumeric code(s), ASCII character(s), a pointer, a memory address, and/or the like.

In the present disclosure, the term “clinical event metadata” may refer to metadata associated with a clinical event data object. For example, the clinical event metadata may comprise text string(s), numerical character(s), alphabetical character(s), alphanumeric code(s), ASCII character(s), and/or the like that describe the clinical event.

For example, an example clinical event data object may describe a visit to a physician by a user. In such an example, the clinical event data object comprises clinical event metadata information such as, but not limited to, healthcare provider name, healthcare service name, and/or the like.

In the present disclosure, the term “relevance measure” may refer to a measure of relevancy of a search result data object according to a search relevance objective. In various embodiments of the present disclosure, different relevance measures are implemented to evaluate the relevancy levels between the search query data object and the search result data object according to different search relevance objectives.

As an example, a search objective may be identifying search results that are textually relevant, and the relevance measure according to such a search objective can be referred to as “textual relevance measure.” In such an example, the higher the textual relevance of the search result data object in relation to the search query data object, the higher the relevance of the search result data object on the textual relevance measure.

Additionally, or alternatively, a search objective may be identifying search results that the user is likely to engage, and the relevance measure according to such a search objective can be referred to as “engagement relevance measure.” In such an example, the more likely that a user engages with the search result data object, the higher the relevance of the search result data object on the engagement relevance measure.

Additionally, or alternatively, a search objective may be identifying search results that are likely to provide value (for example, providing cost-saving values) to the user, and the relevance measure according to such a search objective can be referred to as “outcome relevance measure.” In such an example, the high cost-saving that a search result data object provides to a user, the higher the relevance of the search result data object on the outcome relevance measure.

In the present disclosure, the term “relevance score data object” may refer to a type of data object that indicates a relevance level of a search result data object based at least in part on a relevance measure. For example, the relevance score data object provides qualitative and/or quantitative value(s) that indicate how relevant a search result data object is according to a relevance measure. In some embodiments, the relevance score data object may be in the form of text string(s), numerical character(s), alphabetical character(s), alphanumeric code(s), ASCII character(s), a pointer, a memory address, and/or the like. In the present disclosure, a relevance score data object is also referred to as a relevance label.

In the present disclosure, the term “relevance score data object subset” may refer to a subset of relevance score data objects from a plurality of relevance score data objects. For example, a relevance score data object subset may comprise zero relevance score data object from the plurality of relevance score data objects. As another example, a relevance score data object subset may comprise one relevance score data object from the plurality of relevance score data objects. As another example, a relevance score data object subset may comprise more than one relevance score data object from the plurality of relevance score data objects.

In the present disclosure, the term “textual relevance score data object” may refer to a type of relevance score data object that indicates a relevance level of a search result data object based at least in part on a textual relevance measure as described above. For example, the textual relevance score data object provides a qualitative and/or quantitative relevance value that indicates how relevant a search result data object is according to a textual relevance measure. In this example, the higher the textual relevance of the search result data object in relation to the search query data object, the higher the relevance value of the textual relevance score data object.

As an example, example textual relevance score data objects can be generated by calculating cosine similarity between the query embedding vector of the user query data object and the search result metadata of the search result data object. In such an example, the query embedding vector could be generated from deep learning models that are trained on large corpus such as, but not limited to, universal sentence encoding, BERT-based models (PubMedBERT, BioBERT etc.). Additionally, or alternatively, example textual relevance score data objects are generated from syntactic similarity between the query embedding vector of the user query data object and the search result metadata of the search result data object based at least in part on other techniques such as, but not limited to, jaccard similarity, TF-IDF similarity, and/or the like.

In some embodiments, the textual relevance score data object may be in the form of text string(s), numerical character(s), alphabetical character(s), alphanumeric code(s), ASCII character(s), a pointer, a memory address, and/or the like. In the present disclosure, a textual relevance score data object is also referred to as a textual relevance label.

In the present disclosure, the term “engagement relevance score data object” may refer to a type of relevance score data object that indicates a relevance level of a search result data object based at least in part on an engagement relevance measure as described above. For example, the engagement relevance score data object provides a qualitative and/or quantitative relevance value that indicates how likely a user is going to engage and interact with a search result data object according to an engagement relevance measure. In this example, the higher the likelihood that a user is going to engage and interact with a search result data object, the higher the relevance value of the engagement relevance score data object.

In some embodiments, to generate engagement relevance score data objects associated with search result data objects, such search result data objects are displayed on a user interface according to their textual relevance score data objects, and the search event data objects are generated to record the user interactions with the search result data objects (for example, the click through rate and the impression rates). In some embodiments, one or more machine learning models (such as, but not limited to, Dynamic Bayesian Networks) are implemented to derive engagement relevance score data objects based at least in part on the search event data objects, additional details of which are described herein.

In some embodiments, the engagement relevance score data object may be in the form of text string(s), numerical character(s), alphabetical character(s), alphanumeric code(s), ASCII character(s), a pointer, a memory address, and/or the like. In the present disclosure, an engagement relevance score data object is also referred to as an engagement relevance label.

In the present disclosure, the term “immediate engagement relevance score data object” may refer to a type of engagement relevance score data object that indicates a relevance level of a search result data object based at least in part on the likelihood that a user engages or interacts with the search result indicated by a search result data object directly via the client computing entity. For example, if the search result described by the search result data object requires enrollment or sign-ups, the immediate engagement relevance score data object indicates the likelihood that the user will complete the enrollment or sign-ups immediately or soon after the user receives the search result data object via the client computing entity. In other words, such engagement could be observed immediately after the user performs the searches. In some embodiments, the immediate engagement relevance score data object may be in the form of text string(s), numerical character(s), alphabetical character(s), alphanumeric code(s), ASCII character(s), a pointer, a memory address, and/or the like.

In the present disclosure, the term “delayed engagement relevance score data object” may refer to a type of engagement relevance score data object that indicates a relevance level of a search result data object based at least in part on the likelihood that a user engages or interacts with the search result indicated by a search result data object through one or more clinical events within a post-search observation time period.

In particular, such engagement may not be observed at the same time of receiving the search results data object. For example, it may require some time to observe the occurrence of the clinical event that is caused by receiving the search result data object. For example, a medical visit to a physician after a user search for providers would not happen at the same time of the search, but may happen several days after the search. Various embodiments of the present disclosure provide example methods, apparatuses, and computer program products for generating delayed engagement relevance score data objects by attributing those clinical events to the corresponding search result data object, details of which are described herein. In some embodiments, the delayed engagement relevance score data object may be in the form of text string(s), numerical character(s), alphabetical character(s), alphanumeric code(s), ASCII character(s), a pointer, a memory address, and/or the like.

In the present disclosure, the term “post-search observation time period” may refer to a threshold time period from the time that a search result data object is rendered and presented to a user through the client computing entity and the time that a clinical event occurs. In some embodiments, for an example clinical event to be attributed as relevant to an example search result data object, the example clinical event must occur within the post-search observation time period. In some embodiments, the post-search observation time period is six weeks. In some embodiments, the post-search observation time period is less than or more than six weeks.

In the present disclosure, the term “outcome relevance score data object” may refer to a type of relevance score data object that indicates a relevance level of a search result data object based at least in part on an outcome relevance measure as described above. For example, the outcome relevance score data object provides a qualitative and/or quantitative relevance value that indicates the value (for example, cost-saving in healthcare) that a search result data object will provide to a user according to an outcome relevance measure. In this example, the more cost-savings that a search result data object provides to a user, the higher the relevance value of the outcome relevance score data object. As such, the outcome relevance score data object indicates the affordability of search results to users and quantifies the value of each user engagement or interaction with search result data objects. Various embodiments of the present disclosure generate outcome relevance score data object based at least in part on a dual machine learning model approach, details of which are described herein.

In some embodiments, the outcome relevance score data object may be in the form of text string(s), numerical character(s), alphabetical character(s), alphanumeric code(s), ASCII character(s), a pointer, a memory address, and/or the like.

In the present disclosure, the term “cost difference variable data object” may refer to a type of data object that indicates a cost difference between the estimated future cost related to healthcare if the user engages or interacts with a search result data object and the estimated future cost related to healthcare if the user does not engage or interact with a search result data object. For example, if the search result data object represents data and/or information associated with a medical test, the cost difference variable data object takes into account not the expense of the medical test itself, but also the difference between future medical expenses that the user will likely incur if the user carry out the medical test and the future medical expenses that the user will likely incur if the user does not carry out the medical test. In some embodiments, the cost difference variable data object may be in the form of text string(s), numerical character(s), alphabetical character(s), alphanumeric code(s), ASCII character(s), a pointer, a memory address, and/or the like.

In the present disclosure, the term “event-false cost-estimation machine learning model” may refer to a machine learning model that is trained to generate future cost estimates related to healthcare if the user does not engage in a clinical event that is described in a search result data object. In the present disclosure, the term “event-true cost-estimation machine learning model” may refer to a machine learning model that is trained to generate future cost estimates related to healthcare if the user engages in a clinical event that is described in a search result data object. In some embodiments, the event-false cost-estimation machine learning model and/or the event-true cost-estimation machine learning model may be in the form of regression-based machine learning models (such as, but not limited to, linear regression, decision tree, support vector regression, lasso regression, Random Forest, etc.). Additionally, or alternatively, the event-false cost-estimation machine learning model and/or the event-true cost-estimation machine learning model may be in the form of other machine learning models such as, but not limited to, artificial neural networks.

In the present disclosure, the term “probability matching machine learning model” may refer to a machine learning model that is trained to generate propensity score data objects indicating likelihoods that users engage or participate in a clinical event based at least in part on the corresponding user profile data objects. In some embodiments, an example probability matching machine learning model may be in the form of an artificial neural network, classification-based and/or regression-based machine learning models (such as, but not limited to, decision tree, linear regression, Random Forest, Naive Bayes, etc.), and/or the like.

In the present disclosure, the term “probability-matched user profile data object subset” may refer to a subset of user profile data objects from a plurality of user profile data objects, where each user profile data object in the subset of user profile data objects is associated with a propensity score data object (generated based at least in part on the probability matching machine learning model) that provides the same indication on whether the user is likely to engage with the clinical event. For example, a first probability-matched user profile data object subset comprises user profile data objects associated with the probabilities/likelihood satisfying a threshold (i.e. the users are likely to engage in the clinical event). As another example, a second probability-matched user profile data object subset comprises user profile data objects associated with the probabilities/likelihood not satisfying a threshold (i.e. the users are not likely to engage in the clinical event).

In some examples, a probability-matched user profile data object subset may comprise zero user profile data object from the plurality of user profile data objects. In some examples, a probability-matched user profile data object subset may comprise one user profile data object from the plurality of user profile data objects. In some examples, a probability-matched user profile data object subset may comprise more than one user profile data object from the plurality of user profile data objects.

In the present disclosure, the term “initial ranking data object” may refer to a type of data object that provides an initial ranking of a plurality of search result data objects based at least in part on the user feature vectors and the query feature vectors as described herein. For example, the initial ranking data object may be generated by providing the user feature vectors and the query feature vectors to a machine learning model such as, but not limited to, an artificial neural network, classification-based and/or regression-based machine learning models (such as, but not limited to, decision tree, linear regression, Random Forest, Naive Bayes, etc.), and/or the like. In some embodiments, the initial ranking data object may be in the form of text string(s), numerical character(s), alphabetical character(s), alphanumeric code(s), ASCII character(s), a pointer, a memory address, and/or the like.

In the present disclosure, the term “per-measure optimized ranking data object” may refer to a type of data object that provides a ranking of a plurality of search result data objects based at least in part on their relevance score data objects associated with a relevance measure.

For example, an example per-measure optimized ranking data object may be associated with a textual relevance measure. In such an example, the example per-measure optimized ranking data object may be generated based at least in part on determining textual relevance score data objects associated with the plurality of search result data objects, and ranking the plurality of search result data objects based at least in part on the textual relevance score data objects.

As another example, an example per-measure optimized ranking data object may be associated with an engagement relevance measure. In such an example, the example per-measure optimized ranking data object may be generated based at least in part on determining engagement relevance score data objects associated with the plurality of search result data objects, and ranking the plurality of search result data objects based at least in part on the engagement relevance score data objects.

As another example, an example per-measure optimized ranking data object may be associated with an outcome relevance measure. In such an example, the example per-measure optimized ranking data object may be generated based at least in part on determining outcome relevance score data objects associated with the plurality of search result data objects, and ranking the plurality of search result data objects based at least in part on the outcome relevance score data objects.

In some embodiments, the per-measure optimized ranking data object may be in the form of text string(s), numerical character(s), alphabetical character(s), alphanumeric code(s), ASCII character(s), a pointer, a memory address, and/or the like.

In the present disclosure, the term “ranking comparison score data object” may refer to a type of data object that represents one or more data comparisons between one or more per-measure optimized ranking data objects and the initial ranking data object. In some embodiments, an example ranking comparison score data object may comprise a NDCG score.

For example, a ranking comparison score data object may be generated by comparing the initial ranking data object and the per-measure optimized ranking data object according to the textual relevance measure. As another example, a ranking comparison score data object may be generated by comparing the initial ranking data object and the per-measure optimized ranking data object according to the engagement relevance measure. As another example, a ranking comparison score data object may be generated by comparing the initial ranking data object and the per-measure optimized ranking data object according to the outcome relevance measure.

In some embodiments, the ranking comparison score data object may be in the form of text string(s), numerical character(s), alphabetical character(s), alphanumeric code(s), ASCII character(s), a pointer, a memory address, and/or the like.

In the present disclosure, the term “multi-measure optimized ranking data object” may refer to a type of data object that provides an optimized ranking of a plurality of data objects according to multiple relevance measures such as, but not limited to, the textual relevance measure, the engagement relevance measure, and the outcome relevance measure. In some embodiments, an example multi-measure optimized ranking data object may be generated based at least in part on ranking comparison score data objects, details of which are described herein.

In some embodiments, the multi-measure optimized ranking data object may be in the form of text string(s), numerical character(s), alphabetical character(s), alphanumeric code(s), ASCII character(s), a pointer, a memory address, and/or the like.

In the present disclosure, the term “multi-measure ranking optimization machine learning model” may refer to a machine learning model that is trained to generate multi-measure optimized ranking data objects based at least in part on ranking comparison score data objects. In some embodiments, an example multi-measure ranking optimization machine learning model may be in the form of a LambdaMART machine learning model, which is a combination of LambdaRank and MART (Multiple Additive Regression Trees). In some embodiments, an example multi-measure ranking optimization machine learning model may be in the form of other machine learning model(s).

In the present disclosure, the term “prediction-based action” may refer to one or more computer performed actions that are based at least in part on the multi-measure optimized ranking data object generated in accordance with some embodiments of the present disclosure and associated with one or more predictions and/or estimations of data and/or information in an example multi-measure optimized ranking generation platform/system, details of which are described herein.

c. Exemplary Techniques for Generating Multi-Measure Optimized Ranking Data Objects

As described below, various embodiments of the present invention provide machine learning solutions for improving search accuracy in a search platform that is configured to generate search results for search queries that enables gathering insights from multiple ranking mechanisms into a multi-measure optimized ranking data object that provides comprehensive search result. This leads to a search platform that can generate accurate search results even when underlying search queries fail to contain a large number of semantic inferences. In this way, various embodiments of the present invention reduce the need for end-users of search platforms to do repeated search operations with more precise search queries, which in turn reduces the overall number of search queries transmitted to a search platform and hence the operational load of the search platform. In this way, by reducing the operational load on search platforms, various embodiments of the present invention improve operational reliability and computational efficiency of search platforms.

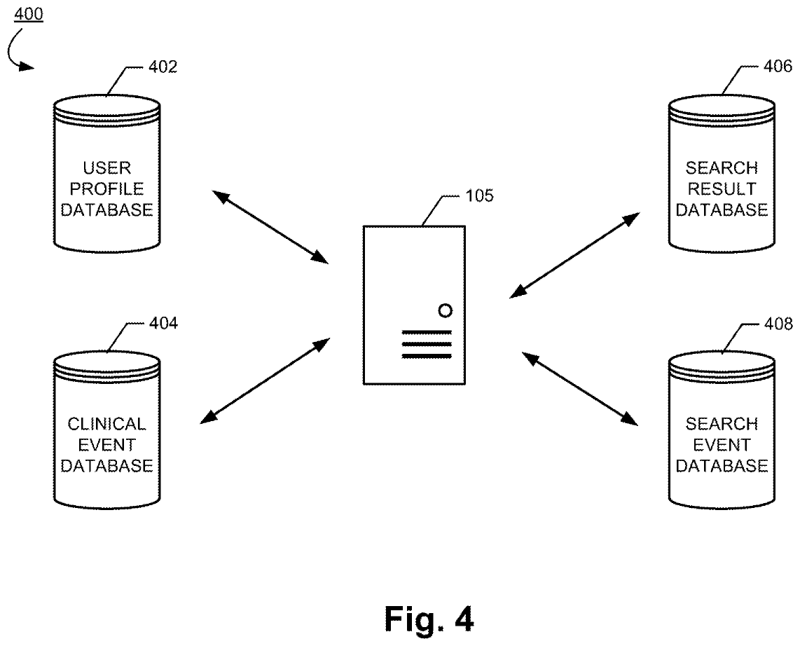

As described and illustrated above in connection with at least FIG. 1 and FIG. 2, various embodiments of the present disclosure utilizes one or more ranking generation computing entities 105. In some embodiments, the one or more ranking generation computing entities 105 is in data communications with one or more network databases. Referring now to FIG. 4, an example schematic representation 400 of data communications between an example ranking generation computing entity and example databases in accordance with various embodiments of the present disclosure is illustrated.

In the example shown in FIG. 4, the one or more ranking generation computing entities 105 exchange data with a user profile database 402. In some embodiments, the user profile database 402 stores user profile data objects, and the one or more ranking generation computing entities 105 retrieve one or more user profile data objects from the user profile database 402. As described above, user profile data objects comprise user profile metadata that represents data and/or information associated with a user. In some embodiments, the one or more ranking generation computing entities 105 generate user feature vectors based at least in part on the user profile metadata from the user profile data objects, details of which are described herein.

In some embodiments, the one or more ranking generation computing entities 105 exchange data with a clinical event database 404. In some embodiments, the clinical event database 404 stores clinical event data objects, and the one or more ranking generation computing entities 105 retrieve one or more clinical event data objects from the clinical event database 404. As described above, the clinical event data objects comprises data and/or information associated with one or more clinical events such as, but not limited to, a visit to a physician's office, a medical test, and/or the like. In some embodiments, the one or more ranking generation computing entities 105 generate delayed engagement relevance score data objects and/or outcome relevance score data objects based at least in part on the clinical event data objects, details of which are described herein.

In some embodiments, the one or more ranking generation computing entities 105 exchange data with the search result database 406. In some embodiments, the search result database 406 stores search result data objects, and the one or more ranking generation computing entities 105 retrieve one or more search result data objects from the search result database 406. In some embodiments, the one or more ranking generation computing entities 105 generate one or more textual relevance score data objects based at least in part on the one or more search result data objects, details of which are described herein.

In some embodiments, the one or more ranking generation computing entities 105 exchange data with the search event database 408. In some embodiments, search event database 408 stores search event data objects, and the one or more ranking generation computing entities 105 retrieve one or more search event data objects from the search event database 408. In some embodiments, the one or more ranking generation computing entities 105 generate immediate engagement relevance score data objects based at least in part on the search event data objects, details of which are described herein.

As described above, there are many technical challenges, deficiencies and problems associated with data retrieval in complex network databases, and various example embodiments of the present disclosure overcome such challenges. For example, referring now to FIG. 5, an example method 500 of generating multi-measure optimized ranking data objects in accordance with embodiments of the present disclosure is illustrated.

For example, the example method 500 may retrieve an initial ranking data object associated with a plurality of search result data objects, retrieve a plurality of relevance score data objects, generate a plurality of ranking comparison score data objects associated with the plurality of relevance measures, and generate a multi-measure optimized ranking data object associated with the plurality of search result data objects. As such, the example method 500 may, for example but not limited to, programmatically generate an optimized ranking to satisfy multiple relevance measures and improve precision and recall of data retrieval in complex network databases.

As shown in FIG. 5, the example method 500 starts at step/operation 501. Subsequent to and/or in response to step/operation 501, the example method 500 proceeds to step/operation 503. At step/operation 503, a computing entity (such as the ranking generation computing entity 105 described above in connection with FIG. 1 and FIG. 2) includes means (such as the processing element 205 of the ranking generation computing entity 105 described above in connection with FIG. 2) to retrieve an initial ranking data object associated with a plurality of search result data objects.

In some embodiments, the initial ranking data object is associated with a plurality of search result data objects. In some embodiments, the plurality of search result data objects are associated with a search query data object.

For example, as described above in connection with FIG. 4, the computing entity is in data communication with the search result database 406. In some embodiments, the search result database 406 stores the plurality of search result data objects that are correlated to search query data objects. As an example, a search query data object may represent a search query from a user for “medical test,” and the search result data objects may represent search results that provide information related to different medical tests offered by different healthcare providers.

In some embodiments, the search result database 406 also stores an initial ranking data object associated with the plurality of search result data objects, and the computing entity retrieves the initial ranking data object from the search result database 406. In some embodiments, the initial ranking data object provides an initial ranking of a plurality of search result data objects. In some embodiments, the initial ranking data object may be generated based at least in part on the user feature vectors and the query feature vectors, details of which are described in connection with at least FIG. 9.

Referring back to FIG. 5, subsequent to and/or in response to step/operation 503, the example method 500 proceeds to step/operation 505. At step/operation 505, a computing entity (such as the ranking generation computing entity 105 described above in connection with FIG. 1 and FIG. 2) includes means (such as the processing element 205 of the ranking generation computing entity 105 described above in connection with FIG. 2) to retrieve a plurality of relevance score data objects.

In some embodiments, each of the plurality of relevance score data objects is associated with one of the plurality of search result data objects described above in connection with step/operation 503 and is associated with one of a plurality of relevance measures.

As described above, a relevance score data object may refer to a type of data object that indicates a relevance level of a search result data object based at least in part on a relevance measure. As such, each relevance score data object is associated with not only a search result data object, but also a relevance measure.

As described above, a relevance measure may refer to a measure of relevancy of a search result data object according to a search objective. In accordance with some embodiments of the present disclosure, example relevance measures comprise textual relevance measure, engagement relevance measure, and outcome relevance measure. In some embodiments, the plurality of relevance score data objects comprises a plurality of textual relevance score data objects that are associated with the textual relevance measure, a plurality of engagement relevance score data objects that are associated with the engagement relevance measure, and a plurality of outcome relevance score data objects that are associated with the outcome relevance measure.

In some embodiments, the plurality of engagement relevance score data objects comprises a plurality of immediate engagement relevance score data objects and a plurality of delayed engagement relevance score data objects, details of which are described in connection with at least FIG. 13 to FIG. 15.

Referring now to FIG. 7, an example diagram 700 illustrates example data correlations between search result data objects and relevance score data objects are provided. In the example shown in FIG. 7, a plurality of search result data objects 701 comprises a search result data object 703A, a search result data object 703B, and/or the like. In some embodiments, each of the search result data object 703A and the search result data object 703B are associated with a plurality of relevance score data objects.

For example, the relevance score data object 705A, the relevance score data object 707A, and the relevance score data object 709A are associated with the search result data object 703A. Similarly, the relevance score data object 705B, the relevance score data object 707B, and the relevance score data object 709B are associated with the search result data object 703B.

In some embodiments, each of the plurality of relevance score data objects shown in FIG. 7 is associated with one of a plurality of relevance measures. For example, the relevance score data object 705A and the relevance score data object 705B are associated with the textual relevance measure. As another example, the relevance score data object 707A and the relevance score data object 707B are associated with the engagement relevance measure. As another example, the relevance score data object 709A and the relevance score data object 709B are associated with the outcome relevance measure.

Referring back to FIG. 5, subsequent to and/or in response to step/operation 505, the example method 500 proceeds to step/operation 507. At step/operation 507, a computing entity (such as the ranking generation computing entity 105 described above in connection with FIG. 1 and FIG. 2) includes means (such as the processing element 205 of the ranking generation computing entity 105 described above in connection with FIG. 2) to generate a plurality of ranking comparison score data objects associated with the plurality of relevance measures.

In some embodiments, to generate the plurality of ranking comparison score data objects, the computing entity generates a per-measure optimized ranking data object associated with the plurality of search result data objects for each of the plurality of relevance measures.

In some embodiments, the computing entity generates a per-measure optimized ranking data object associated with the plurality of search result data objects for the textual relevance measure, generates a per-measure optimized ranking data object associated with the plurality of search result data objects for the engagement relevance measure, and generates a per-measure optimized ranking data object associated with the plurality of search result data objects for the outcome relevance measure.

As described above, each of the plurality of ranking comparison score data objects represents a data comparison between one or more of the per-measure optimized ranking data objects and the initial ranking data object. In some embodiments, the example ranking comparison score data object may comprise a NDCG score. Additional details associated with generating the ranking comparison score data objects are described in connection with at least FIG. 6.

Referring back to FIG. 5, subsequent to and/or in response to step/operation 507, the example method 500 proceeds to step/operation 509. At step/operation 509, a computing entity (such as the ranking generation computing entity 105 described above in connection with FIG. 1 and FIG. 2) includes means (such as the processing element 205 of the ranking generation computing entity 105 described above in connection with FIG. 2) to generate a multi-measure optimized ranking data object associated with the plurality of search result data objects.

In some embodiments, the computing entity generates the multi-measure optimized ranking data object based at least in part on inputting the plurality of ranking comparison score data objects generated at step/operation 507 to a multi-measure ranking optimization machine learning model.

As described above, the multi-measure optimized ranking data object provides an optimized ranking of a plurality of data objects according to multiple relevance measures such as, but not limited to, the textual relevance measure, the engagement relevance measure, and the outcome relevance measure. For example, after a plurality of search result data objects associated with a search query data object are determined, various embodiments of the present disclosure implements a multi-objective ranking optimization framework. In some embodiments, the multi-objective ranking optimization framework is associated with a plurality of ranking objects (e.g. relevance measures such as, but not limited to, the textual relevance measure, the engagement relevance measure, and the outcome relevance measure). In some embodiments, the multi-objective ranking optimization framework ranks the plurality of search result data objects based at least in part on one or more sub-objectives but without compromising too much on the primary objective.

Multi-objective ranking builds on top of the Learning-to-Rank (LTR) approach for ranking. LTR is an application of machine learning techniques to information retrieval. The idea is to learn a function that is able to rank query-result pairs in search from relevance score data objects (e.g. relevance labels) derived from user activities such as clicks versus impressions. NDCG is one of the metrics that can be used to evaluate the quality of a ranking from LTR models. NDCG is order-dependent and prefers placing highly relevant documents at the top.

LTR algorithms extend the use of optimizing ranking for a single objective (e.g. optimize NDCG for relevance labels derived from clicks versus impressions from users). The multi-objective ranking optimization framework applies optimization constraints to a LTR problem and extends it to optimize for multiple objectives.

The underlying LTR algorithm for the multi-objective ranking optimization framework implements a machine learning model such as, but not limited to, LambdaMART. LambdaMART is a pairwise gradient boosted tree (GBT) based method. The cost function for LambdaMART is cross entropy of probability of predicted pairwise relevance and the true probability of relevance across all pairs of search results for all queries, summed over all queries in the dataset. In some embodiments, the true probability of the query-result pair x_i, x_j given a query q is given by Pij=0.5(1+S_ij). S_ij will be 1 if the relevance(x_i)>relevance(x_j). S_ij will be −1 for the opposite case. S_ij will be 0 if relevance labels for both x_i and x_j are the same. The gradients for LambdaMART have been empirically shown to be as a function of change in NDCG (obtained by swapping ranks of two items) and that of scores from the ranking function.

Multi-objective ranking optimization framework adds the idea of constrained optimization to LTR by converting the original constrained problem to an unconstrained problem with additional penalty terms that penalize constraint violations (dual form with Lagrange multipliers). The constraints are defined as the upper bounds on training costs for the sub-objectives. Because lower cost means better ranking, the optimization problem then attempts to minimize the cost of the primary objective given the constraint that cost of ranking on sub-objectives is also reduced by a fixed upper bound percentage. For example, the upper bound can be 5-50% of the original cost (cost reduction) obtained by training exclusively on the sub-objectives. Calculating gradients and updating duals work simultaneously in the boosting steps during training the LambdaMART machine learning model, which makes it an iterative algorithm that can be trained over the entire dataset:

Problem:minCpm(s)s.t.Cₜ(s)bₜ, t=1, . . . ,T(set T are the sub-objectives).

In other words, the multi-objective ranking optimization framework is better at learning how to rank additional objectives (in case of unified search, sub-objectives are HAI, steerage, etc.) but with a bounded compromise on the primary objective (in case of unified search, the primary objective is ranking by clicks versus impressions rates). In some embodiments, stricter constraint on upper bounds of cost for sub-objective means a worse performance on the primary objective, and the multi-objective ranking optimization framework provides the right trade-off between the two.

Referring back to FIG. 5, as an example, the primary objective is assigned to the textual relevance measure (e.g. syntactic/semantic relevance, immediate engagement relevance), and the sub-objectives are assigned to engagement relevance measure and outcome relevance measure. In this example, a multi-measure ranking optimization machine learning model is utilized to generate the multi-measure optimized ranking data object. For example, the multi-measure ranking optimization machine learning model may be in the form of a LambdaMART machine learning model. In some embodiments, the multi-measure ranking optimization machine learning model may be trained or fine-tuned by placing lower bounds on textual relevance/user engagement sub-objective and upper bounds on HAI and affordability sub-objective.

As such, various embodiments of the present disclosure solve a constrained optimization problem that optimized NDCG score for the textual relevance/immediate user engagement in addition to the other sub-objectives by, for example, trading off worse NDCG score from textual/engagement sub-objective for an increased NDCG from HAI and affordability sub-objectives. NDCG is an error metric to measure quality of a ranked list adjusted for position of higher relevance results in the ranked list as higher quality. For example, assuming a set of results {r1, r2, r3} with relevance labels {1, 0, 2}, NDCG score for ranking {2, 1, 0} will be greater than NDCG score for ranking {0, 2, 1}. While stricter constraint on upper bounds of cost for the other two sub-objective means a worse performance on the first sub-objective, various embodiments of the present discourse provide the right trade-off between the two with constrained optimization:

Problem:minCₜ₁(s)s.t.Cₜₓ(s)≤bₜₓ, {x=HAI,affordability,T₁=textual/immediate user engagement}

Referring back to FIG. 5, subsequent to and/or in response to step/operation 509, the example method 500 proceeds to step/operation 511. At step/operation 511, a computing entity (such as the ranking generation computing entity 105 described above in connection with FIG. 1 and FIG. 2) includes means (such as the processing element 205 of the ranking generation computing entity 105 described above in connection with FIG. 2) to perform one or more prediction-based actions based at least in part on the multi-measure optimized ranking data object.

For example, the computing entity causes rendering a prediction user interface in a display of a client computing entity. In such an example, the prediction user interface may comprise renderings of the plurality of search result data objects, and the renderings of the plurality of search result data objects are arranging according to the multi-measure optimized ranking data object generated by the multi-measure ranking optimization machine learning model. As such, various embodiments of the present disclosure provide search results on the prediction user interface that are ranked based at least in part on predicted relevance to users and optimized for multiple relevance measures, which provides technical benefits and advantages such as, but not limited to, improving the accuracy and precision in data retrieval from complex network databases and improving user search experience.

While the description above provides an example of a prediction-based action, it is noted that the scope of the present disclosure is not limited to the description above. In some examples, an example prediction-based action may be in other form(s).

Referring back to FIG. 5, subsequent to and/or in response to step/operation 511, the example method 500 proceeds to step/operation 513 and ends.

Referring now to FIG. 6, an example method 600 of generating ranking comparison score data objects in accordance with embodiments of the present disclosure is illustrated.

For example, the example method 600 may determine a relevance score data object subset associated with the plurality of search result data objects and associated with a relevance measure of the plurality of relevance measures, generate a per-measure optimized ranking data object associated with the plurality of search result data objects and the relevance measure, and generate a ranking comparison score data object associated with the relevance measure based at least in part on the per-measure optimized ranking data object and the initial ranking data object. As such, the example method 600 may, for example but not limited to, provide technical benefits and advantages such as, but not limited to, improving the accuracy and precision in data retrieval from complex network databases and improving user search experience.

As shown in FIG. 6, the example method 600 starts at block A, which is connected to step/operation 507 of FIG. 5. In some embodiments, to perform the step/operation 507 of FIG. 5 (e.g. to generate the plurality of ranking comparison score data objects associated with the plurality of relevance measures), an example method proceeds to step/operation 602. At step/operation 602, a computing entity (such as the ranking generation computing entity 105 described above in connection with FIG. 1 and FIG. 2) includes means (such as the processing element 205 of the ranking generation computing entity 105 described above in connection with FIG. 2) to determine a relevance score data object subset associated with the plurality of search result data objects and associated with a relevance measure of the plurality of relevance measures.

In some embodiments, the computing entity determines the relevance score data object subset from a plurality of relevance score data objects. As described above, each relevance score data object is associated with one of a plurality of search result data objects and one of a plurality of relevance measures.

For example, referring now to the example FIG. 7, the computing entity may determine that, from the plurality of relevance score data objects comprising relevance score data object 705A, relevance score data object 707A, relevance score data object 709A, relevance score data object 705B, relevance score data object 707B, and relevance score data object 709B, both the relevance score data object 705A and the relevance score data object 705B are associated with the same relevance measure (for example, textual relevance measure). In addition, relevance score data object 705A is associated with search result data object 703A, and relevance score data object 705B is associated with search result data object 703B. In this example, the computing entity determines a relevance score data object subset that comprises the relevance score data object 705A and the relevance score data object 705B because they are associated with the same relevance measure and the plurality of search result data objects 701 (e.g. search result data object 703A and search result data object 703B).

Referring back to FIG. 6, subsequent to and/or in response to step/operation 602, the example method 600 proceeds to step/operation 604. At step/operation 604, a computing entity (such as the ranking generation computing entity 105 described above in connection with FIG. 1 and FIG. 2) includes means (such as the processing element 205 of the ranking generation computing entity 105 described above in connection with FIG. 2) to generate a per-measure optimized ranking data object associated with the plurality of search result data objects and the relevance measure.

As described above, the per-measure optimized ranking data object may refer to a type of data object that provides a ranking of a plurality of search result data objects based at least in part on their relevance score data objects associated with a relevance measure. In some embodiments, the computing entity generates the per-measure optimized ranking data object based at least in part on the relevance score data object subset determined at step/operation 602.

Referring to the example show in FIG. 7, the computing entity generate a per-measure optimized ranking data object associated with the plurality of search result data objects 701 and the relevance measure that is associated with the relevance score data object 705A and the relevance score data object 705B (e.g. textual relevance measure). For example, the computing entity compares the value of the relevance score data object 705A with the value of the relevance score data object 705B. If the value of the relevance score data object 705A is higher than the value of the relevance score data object 705B, the computing entity provides a higher ranking of the search result data object 703A in the per-measure optimized ranking data object as compared to the ranking of the search result data object 703B.

Referring back to FIG. 6, subsequent to and/or in response to step/operation 604, the example method 600 proceeds to step/operation 606. At step/operation 606, a computing entity (such as the ranking generation computing entity 105 described above in connection with FIG. 1 and FIG. 2) includes means (such as the processing element 205 of the ranking generation computing entity 105 described above in connection with FIG. 2) to generate a ranking comparison score data object associated with the relevance measure based at least in part on the per-measure optimized ranking data object and the initial ranking data object.

In some embodiments, the computing entity generates a ranking comparison score data object associated with the relevance measure based at least in part on the per-measure optimized ranking data object generated at step/operation 604 and an initial ranking data object (for example, the initial ranking data object retrieved at step/operation 503 as described above in connection with FIG. 5).

As described above, the ranking comparison score data object represents one or more data comparisons between one or more per-measure optimized ranking data objects and the initial ranking data object. In some embodiments, the computing entity generates the ranking comparison score data object based at least in part on calculating a NDCG score associated with the per-measure optimized ranking data object and initial ranking data object.

While the description above provides an example of a ranking comparison score data object based at least in part on one per-measure optimized ranking data object and the initial ranking data object, it is noted that the scope of the present disclosure is not limited to the description above. In some examples, an example ranking comparison score data object may indicate one or more data comparisons between multiple per-measure optimized ranking data objects and the initial ranking data object.

Referring back to FIG. 6, subsequent to and/or in response to step/operation 606, the example method 600 proceeds to step/operation 608. At step/operation 608, a computing entity (such as the ranking generation computing entity 105 described above in connection with FIG. 1 and FIG. 2) includes means (such as the processing element 205 of the ranking generation computing entity 105 described above in connection with FIG. 2) to determine whether all relevance measures have been analyzed.

As described above, various embodiments of the present discourse implement multiple relevance measures to generate a multi-measure optimized ranking data object. At step/operation 608, the computing entity determines whether a per-measure optimized ranking data object (and/or a ranking comparison score data object) has been generated for each of the relevance measures.

If, at step/operation 608, the computing entity determines that not all relevance measures have been analyzed (e.g. no per-measure optimized ranking data object (and/or ranking comparison score data object) has been generated for at least one relevance measure), the example method 600 returns to step/operation 602. Similar to those described above, the computing entity determines a relevance score data object subset associated with the relevance measure that has not been analyzed, generates a per-measure optimized ranking data object, and generates a ranking comparison score data object associated with the relevance measure.

If, at step/operation 608, the computing entity determines that all relevance measures have been analyzed, the example method 600 proceeds to block B, which connects back to step/operation 507 of FIG. 5. Similar to those described above in connection with FIG. 5, the computing entity generates a multi-measure optimized ranking data object associated with the plurality of search result data objects based at least in part on inputting the plurality of ranking comparison score data objects (generated in accordance with the example method 600 shown in FIG. 6) to a multi-measure ranking optimization machine learning model.

Referring now to FIG. 8, an example multi-objective ranking optimization framework 800 in accordance with some embodiments of the present disclosure is illustrated.

In the example shown in FIG. 8, the example multi-objective ranking optimization framework 800 includes generating the initial ranking data object 806 based at least in part on the features vectors 802 associated with a plurality of search result data objects and the user profile data object. Examples of the features vectors 802 include, but are not limited to, socio-economic user embedding vectors, search history embedding vectors, medical history embedding vectors, relevance scores (e.g. query-item relevance vectors), and query embedding vectors.

In some embodiments, the example multi-objective ranking optimization framework 800 includes generating the per-measure optimized ranking data objects 808 in accordance with embodiments of the present disclosure. For example, each of the per-measure optimized ranking data objects 808 provides a ranking of the plurality of search result data objects associated with the initial ranking data object 806 based at least in part on their relevance score data objects associated with a relevance measure.

In some embodiments, the example multi-objective ranking optimization framework 800 includes generating the ranking comparison score data objects 810, similar to those described herein in connection with at least FIG. 5 to FIG. 7. In some embodiments, the example multi-objective ranking optimization framework 800 comprises providing the ranking comparison score data objects 810 to the multi-measure ranking optimization machine learning model 812.

In the example shown in FIG. 8, the multi-measure ranking optimization machine learning model 812 has been trained and/or fine-tuned based at least in part on the constrained optimization 814. In some embodiments, the multi-measure ranking optimization machine learning model 812 generates a multi-measure optimized ranking data object 816 in accordance with some embodiments of the present disclosure. In some embodiments, the multi-measure ranking optimization machine learning model 812 further adjusts the model weights 804 (which are associated with the features vectors 802 in generating the initial ranking data object 806) based at least in part on the multi-measure optimized ranking data object 816. For example, the multi-measure ranking optimization machine learning model 812 adjusts the model weights associated with the features vectors 802 so that the ranking provided in the initial ranking data object 806 is more similar to the ranking provided in the multi-measure optimized ranking data object 816.

Accordingly, as described above, various embodiments of the present invention provide machine learning solutions for improving search accuracy in a search platform that is configured to generate search results for search queries that enables gathering insights from multiple ranking mechanisms into a multi-measure optimized ranking data object that provides comprehensive search result. This leads to a search platform that can generate accurate search results even when underlying search queries fail to contain a large number of semantic inferences. In this way, various embodiments of the present invention reduce the need for end-users of search platforms to do repeated search operations with more precise search queries, which in turn reduces the overall number of search queries transmitted to a search platform and hence the operational load of the search platform. In this way, by reducing the operational load on search platforms, various embodiments of the present invention improve operational reliability and computational efficiency of search platforms.

d. Exemplary Techniques for Generating Initial Ranking Data Objects

As described above, there are technical challenges, deficiencies and problems associated with database systems, and various example embodiments of the present disclosure overcome such challenges. For example, referring now to FIG. 9, an example method 900 of generating initial ranking data objects in accordance with embodiments of the present disclosure is illustrated.

For example, the example method 900 may retrieve a user profile data object associated with the search query data object, generate a plurality of user feature vectors associated with the user profile data object, generate a plurality of query feature vectors based at least in part on the search query data object, and generate the initial ranking data object based at least in part on the plurality of user feature vectors and the plurality of query feature vectors. As such, the example method 900 may, for example but not limited to, provide technical benefits and advantages such as, but not limited to, improving accuracy and precision in data retrieval from complex network databases and improving user search experience.

As shown in FIG. 9, the example method 900 starts at step/operation 901. Subsequent to and/or in response to step/operation 901, the example method 900 proceeds to step/operation 903. At step/operation 903, a computing entity (such as the ranking generation computing entity 105 described above in connection with FIG. 1 and FIG. 2) includes means (such as the processing element 205 of the ranking generation computing entity 105 described above in connection with FIG. 2) to retrieve a user profile data object associated with the search query data object.

As described above, a user profile data object may refer to a type of data object that comprises data and/or information associated with a user. For example, the user profile data object is associated with the user who initiated the search query data object.

In some embodiments, the user profile data object comprises user profile metadata. For example, as described above, the user profile metadata may comprise user socio-economic metadata, user demographics characteristics metadata, user search history metadata, user medical history metadata, and/or the like. In some embodiments, the user socio-economic metadata describes social and economic factors associated with the user (for example, but not limited to, family income, education level, and/or the like). In some embodiments, the user demographics characteristics metadata describes demographics characteristics associated with the user (for example, but not limited to, age, gender, household size, and/or the like). In some embodiments, the user search history metadata describes the previous search query data objects associated with the user (for example, previous search queries that have been submitted by the user). In some embodiments, the user medical history metadata describes medical history associated with the user (for example, medical claims that have been submitted by the user in the past).

Referring back to FIG. 9, subsequent to and/or in response to step/operation 903, the example method 900 proceeds to step/operation 905. At step/operation 905, a computing entity (such as the ranking generation computing entity 105 described above in connection with FIG. 1 and FIG. 2) includes means (such as the processing element 205 of the ranking generation computing entity 105 described above in connection with FIG. 2) to generate a plurality of user feature vectors associated with the user profile data object.

In some embodiments, the computing entity generates the plurality of user feature vectors associated with the user profile data object based at least in part on the user profile metadata associated with the user profile data object retrieved at step/operation 903.

In some embodiments, the plurality of user feature vectors comprises one or more of user socio-economics embedding vectors, one or more user demographics characteristics vectors, one or more user search history embedding vectors, and one or more user medical history embedding vectors. For example, the user socio-economics embedding vector is associated with user socio-economic metadata of a user profile data object. As another example, the user demographics characteristics vector is associated with the user demographics characteristics metadata of the user profile data object. As another example, the user search history embedding vector is associated with the user search history metadata of the user profile data object. As another example, the user medical history embedding vector is associated with the user medical history metadata of the user profile data object.

In some embodiments, the plurality of user feature vectors are generated based at least in part on providing the corresponding metadata of the user profile data object to an encoder. In some embodiments, the plurality of user feature vectors are generated by implementing techniques such as word2vec on the corresponding metadata of the user profile data object. In some embodiments, the plurality of user feature vectors are generated by providing the corresponding metadata of the user profile data object to pre-trained deep learning models.

Referring back to FIG. 9, subsequent to and/or in response to step/operation 905, the example method 900 proceeds to step/operation 907. At step/operation 907, a computing entity (such as the ranking generation computing entity 105 described above in connection with FIG. 1 and FIG. 2) includes means (such as the processing element 205 of the ranking generation computing entity 105 described above in connection with FIG. 2) to generate a plurality of query feature vectors based at least in part on the search query data object.

In some embodiments, the plurality of query feature vectors comprises one or more of query embedding vectors and query-item relevance vectors.

As described above, an example query embedding vector is generated from syntactic representations and/or semantic representations. In some embodiments, the syntactic representations are generated based at least in part on techniques such as, but not limited to, TF-IDF and/or the like. In some embodiments, the semantic representations are generated based at least in part on, for example but not limited to, providing the search query data object to a machine learning model such as, but not limited to, a deep learning model (e.g. BERT, etc.).

As described above, an example query-item relevance vector associated with search query data object may be generated based at least in part on calculating cosine similarities between the query embedding vector of the search query data object and the search result metadata associated with one or more search result data objects that are in response to the search query data object.

Referring back to FIG. 9, subsequent to and/or in response to step/operation 907, the example method 900 proceeds to step/operation 909. At step/operation 909, a computing entity (such as the ranking generation computing entity 105 described above in connection with FIG. 1 and FIG. 2) includes means (such as the processing element 205 of the ranking generation computing entity 105 described above in connection with FIG. 2) to generate the initial ranking data object based at least in part on the plurality of user feature vectors and the plurality of query feature vectors.

For example, the computing entity may provide the plurality of user feature vectors and the plurality of query feature vectors to an initial ranking machine learning model. In some embodiments, the initial ranking machine learning model has been pre-trained to generate an initial ranking in response to receiving the plurality of user feature vectors and the plurality of query feature vectors. In some embodiments, the initial ranking machine learning model is personalized based at least in part on the user profile data object. In some embodiments, the initial ranking machine learning model may be in the form of an artificial neural network, classification-based and/or regression-based machine learning models (such as, but not limited to, decision tree, linear regression, Random Forest, Naive Bayes, etc.), and/or the like.

Referring back to FIG. 9, subsequent to and/or in response to step/operation 909, the example method 900 proceeds to step/operation 911 and ends.

e. Exemplary Techniques for Generating Textual Relevance Score Data Objects

As described above, there are technical challenges, deficiencies and problems associated with database systems, and various example embodiments of the present disclosure overcome such challenges. For example, referring now to FIG. 10, an example method 1000 of generating textual relevance score data objects in accordance with embodiments of the present disclosure is illustrated.

For example, the example method 1000 may generate a plurality of query feature vectors based at least in part on the search query data object, determine a plurality of search result metadata that are associated with the plurality of search result data objects, and generate the plurality of textual relevance score data objects based at least in part on the plurality of search result metadata and the plurality of query feature vectors. As such, the example method 1000 may, for example but not limited to, provide technical benefits and advantages such as, but not limited to, improving accuracy and precision in data retrieval from complex network databases and improving user search experience.

As shown in FIG. 10, the example method 1000 starts at step/operation 1002. Subsequent to and/or in response to step/operation 1002, the example method 1000 proceeds to step/operation 1004. At step/operation 1004, a computing entity (such as the ranking generation computing entity 105 described above in connection with FIG. 1 and FIG. 2) includes means (such as the processing element 205 of the ranking generation computing entity 105 described above in connection with FIG. 2) to generate a plurality of query feature vectors based at least in part on the search query data object.

In some embodiments, the computing entity generates the plurality of query feature vectors similar to those described above in connection with at least FIG. 9.

For example, the query feature vectors are generated from deep learning models trained on large corpus (e.g. universal sentence encoding, BERT-based models (PubMedBERT, BioBERT), etc.). Additionally, or alternatively, the query feature vectors are generated based at least in part on techniques such as, but not limited to, word2vec.

Referring back to FIG. 10, subsequent to and/or in response to step/operation 1004, the example method 1000 proceeds to step/operation 1006. At step/operation 1006, a computing entity (such as the ranking generation computing entity 105 described above in connection with FIG. 1 and FIG. 2) includes means (such as the processing element 205 of the ranking generation computing entity 105 described above in connection with FIG. 2) to determine a plurality of search result metadata that are associated with the plurality of search result data objects.

In some embodiments, the plurality of search result data objects are generated in response to a search query data object and are therefore associated with the search query data object.

As described above, each of the plurality of search result metadata may comprise search result metadata. As such, the computing entity may determine search result metadata by extracting search result metadata that are associated with the plurality of search result data objects.

For example, if the search query data object is associated with a search query for “primary care physician,” the search result metadata may comprise a text string that corresponds to the healthcare provider name and a text string that corresponds to the healthcare service name. As another example, if the search query data object is associated with a search query for “medical test,” the search result metadata may comprise one or more text strings that correspond to the names of medical laboratories that offer medical tests and one or more text strings that correspond to the location(s) of the medical laboratories that offer medical tests.

Referring back to FIG. 10, subsequent to and/or in response to step/operation 1006, the example method 1000 proceeds to step/operation 1008. At step/operation 1008, a computing entity (such as the ranking generation computing entity 105 described above in connection with FIG. 1 and FIG. 2) includes means (such as the processing element 205 of the ranking generation computing entity 105 described above in connection with FIG. 2) to generate the plurality of textual relevance score data objects based at least in part on the plurality of search result metadata and the plurality of query feature vectors.

In some embodiments, for each of the plurality of search result data objects, the computing entity generates a textual relevance score data object by calculating a cosine similarity score between the query feature vector associated with the query data object and search result metadata associated with the search result data object. In such examples, the textual relevance score data object comprises the cosine similarity score.

In some embodiments, for each of the plurality of search result data objects, the computing entity generates a textual relevance score data object by calculating syntactic similarity score (based at least in part on jaccard similarity or TF-IDF similarity) between the query feature vector associated with the query data object and search result metadata associated with the search result data object. In such examples, the textual relevance score data object comprises the syntactic similarity score.

While the description above provides examples of calculating textual relevance score data objects, it is noted that the scope of the present disclosure is not limited to the description above.

Referring back to FIG. 10, subsequent to and/or in response to step/operation 1008, the example method 1000 proceeds to step/operation 1010 and ends.

f. Exemplary Techniques for Generating Engagement Relevance Score Data Objects

As described above, there are technical challenges, deficiencies and problems associated with database systems, and various example embodiments of the present disclosure overcome such challenges. For example, referring now to FIG. 11, an example method 1100 of generating engagement relevance score data objects in accordance with embodiments of the present disclosure is illustrated.

For example, the example method 1100 may retrieve a plurality of search event data objects associated with the plurality of search result data object, generate one or more attractiveness variable data objects, one or more examination variable data objects, and one or more satisfaction variable data objects, and generate the plurality of engagement relevance score data objects. As such, the example method 1100 may, for example but not limited to, provide technical benefits and advantages such as, but not limited to, improving accuracy and precision in data retrieval from complex network databases and improving user search experience.

As shown in FIG. 11, the example method 1100 starts at step/operation 1101. Subsequent to and/or in response to step/operation 1101, the example method 1100 proceeds to step/operation 1103. At step/operation 1103, a computing entity (such as the ranking generation computing entity 105 described above in connection with FIG. 1 and FIG. 2) includes means (such as the processing element 205 of the ranking generation computing entity 105 described above in connection with FIG. 2) to retrieve a plurality of search event data objects associated with a plurality of search result data object.

In some embodiments, the plurality of search result data objects are displayed based at least in part on the textual relevance score data object or the initial ranking data object associated with the plurality of search result data objects. In some embodiments, the plurality of search event data objects are associated with the plurality of search result data objects as the plurality of search event data objects comprises data and/or information associated with user engagement and/or interactions with one or more of the plurality of search result data objects. In some embodiments, the plurality of search event data objects comprises search result view metadata, search result selection metadata, and search result completion metadata.

As described above, the search result view metadata indicates whether a user has viewed one or more search result data objects, and the search result selection metadata indicates whether a user has selected one or more search result data objects. In some embodiments, the search result view metadata represents the search impression rate, and the search result completion metadata represents the search click-through rate. In some embodiments, the search click-through rate versus the search impression rate can be determined based at least in part on the search result completion metadata and the search result view metadata.

Referring back to FIG. 11, subsequent to and/or in response to step/operation 1103, the example method 1100 proceeds to step/operation 1105. At step/operation 1105, a computing entity (such as the ranking generation computing entity 105 described above in connection with FIG. 1 and FIG. 2) includes means (such as the processing element 205 of the ranking generation computing entity 105 described above in connection with FIG. 2) to generate one or more attractiveness variable data objects, one or more examination variable data objects, and one or more satisfaction variable data objects.

In some embodiments, attractiveness variable data objects, examination variable data objects, and satisfaction variable data objects are associated with the plurality of search result data objects described above in connection with step/operation 1103. For example, attractiveness variable data objects, examination variable data objects, and satisfaction variable data objects are generated based at least in part on the search result selection metadata described above in connection with at least step/operation 1103.

In some embodiments, the attractiveness variable data object in the form of a binary variable (Aᵢ). For example, Aᵢ equals one (1) if a user associated with the user profile data object clicks on or selects the search result data object i, and Aᵢ equals zero (0) if a user associated with the user profile data object does not click on or select the search result data object i.

In some embodiments, the examination variable data object is in the form of a binary variable (Eᵢ). For example, Eᵢ equals one (1) if the search result data object i is the last search result data object that is last clicked or selected by the user associated with the user profile data object on the list of search result data objects, or if the search result data object i is listed above the last search result data object that is last clicked or selected by the user associated with the user profile data object. Eᵢ equals zero (0) if the search result data object i is listed below the last search result data object that is last clicked or selected by the user associated with the user profile data object.

In some embodiments, the satisfaction variable data object is in the form of a binary variable (Sᵢ). For example, Sᵢ equals one (1) if the search result data object i is the last search result data object that is last clicked or selected by the user associated with the user profile data object from the list of search result data objects. In addition, the last search result data object is counted if (a) the user does not press the back button on the user interface to return to previous renderings of previous search result data objects after viewing the rendering of the search result data object and (b) the user does not submit a new search query within a time window after viewing the rendering of the search result data object (for example but not limited to, within the next 15 minutes after viewing the rendering of the search result data object). If the search result data object i is not the last search result data object that is last clicked or selected by the user associated with the user profile data object or if it does not satisfy both condition (a) and (b) above, Sᵢ equals zero (0).

Referring back to FIG. 11, subsequent to and/or in response to step/operation 1105, the example method 1100 proceeds to step/operation 1107. At step/operation 1107, a computing entity (such as the ranking generation computing entity 105 described above in connection with FIG. 1 and FIG. 2) includes means (such as the processing element 205 of the ranking generation computing entity 105 described above in connection with FIG. 2) to generate the plurality of engagement relevance score data objects.

In some embodiments, the computing entity generates the plurality of engagement relevance score data objects based at least in part on inputting the one or more attractiveness variable data objects, the one or more examination variable data objects, and the one or more satisfaction variable data objects (that are described above in connection with at least step/operation 1105) to an engagement relevance machine learning model. For example, the engagement relevance machine learning model may be in the form of Dynamic Bayesian Networks.

Referring now to FIG. 12, an example Dynamic Bayesian Network diagram 1200 in accordance with some embodiments of the present disclosure is illustrated. In the example shown in FIG. 12, an example Dynamic Bayesian Network is implemented to generate an engagement relevance score data object associated with an example search result data object 1202A, and to generate an engagement relevance score data object associated with an example search result data object 1202B.

In this example, the example search result data object 1202A and the example search result data object 1202B are positioned next to one another based at least in part on the ranking according to the textual relevance score data object and/or the initial ranking data object described above. In this example, the search result data object 1202A is ranked higher than the example search result data object 1202B.

In some embodiments, the computing entity provides attractiveness variable data objects, examination variable data objects, and satisfaction variable data objects associated with the example search result data object 1202A and the example search result data object 1202B to the example Dynamic Bayesian Network diagram 1200. For example, the example search result data object 1202A is associated with the attractiveness variable data object A_{UR}, the examination variable data object E_{R}, and the satisfaction variable data object S_{UR} The example search result data object 1202B is associated with the attractiveness variable data object A_{UR+1}, the examination variable data object E_{R+1}, and the satisfaction variable data object S_{UR+1}. In addition, FIG. 12 further illustrates the search result selection metadata Click_{R} and the search result completion metadata Complete_{UR} associated with the example search result data object 1202A, as well as the search result selection metadata Click_{R+1} and the search result completion metadata Complete_{UR+2} associated with the example search result data object 1202B.

In some embodiments, the example Dynamic Bayesian Network mines the relevance score data objects by introducing binary variables at a position i in the ranking list to model click (attractiveness), examination and satisfaction of the search result. In such examples, it is assumed that a user keeps examining results from top to bottom until he is satisfied, which means that no items below the last click in the list are examined. For example, in some embodiments, the relevance score data object of a search result data object i is defined as:

R_{q}=P(Sᵢ=1/Eᵢ=1)=P(Sᵢ=1/Aᵢ=1)*P(Aᵢ=1/Eᵢ=1)

In the above equation and as shown in FIG. 12, A is the attractiveness variable data object of the search result data object, S is the satisfaction variable data object of the search result data object, E is the examination variable data object of the search result data object, u represents the search result, R represents the rank of the search result, and Smart rack power access point represents probability.

As such, the example Dynamic Bayesian Network can derive and empirically compute engagement relevance score data objects for the search result data object based at least in part on search event metadata associated with the search event data objects related to the search result data object.

While the description above provides an example of generating engagement relevance score data objects, it is noted that the scope of the present disclosure is not limited to the description above. In some examples, an example engagement relevance score data object may be generated through other ways. For example, the outcome defined in Dynamic Bayesian Network model could be extended to include other engagement metrics in addition to or in alternative of search result selection metadata (“click”) and search result completion metadata (“completion”).

Referring back to FIG. 11, subsequent to and/or in response to step/operation 1107, the example method 1100 proceeds to step/operation 1109 and ends.

As described above, there are technical challenges, deficiencies and problems associated with database systems, and various example embodiments of the present disclosure overcome such challenges. For example, referring now to FIG. 13, an example method 1300 of generating immediate engagement relevance score data objects in accordance with embodiments of the present disclosure is illustrated.

For example, the example method 1300 retrieves a plurality of search event data objects associated with the plurality of search result data objects and generates the plurality of immediate engagement relevance score data objects based at least in part on the search result completion metadata of the plurality of search event data objects. As such, the example method 1300 may, for example but not limited to, provide technical benefits and advantages such as, but not limited to, improving accuracy and precision in data retrieval from complex network databases and improving user search experience.

As shown in FIG. 13, the example method 1300 starts at step/operation 1301. Subsequent to and/or in response to step/operation 1301, the example method 1300 proceeds to step/operation 1303. At step/operation 1303, a computing entity (such as the ranking generation computing entity 105 described above in connection with FIG. 1 and FIG. 2) includes means (such as the processing element 205 of the ranking generation computing entity 105 described above in connection with FIG. 2) to retrieve a plurality of search event data objects associated with the plurality of search result data objects.

In some embodiments, the plurality of search event data object comprises search result completion metadata. As described above, the search result completion metadata indicates whether a user has immediately engaged or interacted with the search result indicated by a search result data object right after the search event (for example, directly via the client computing entity). Such engagement could be observed immediately or soon after a user performs the search and receives search result data objects. For example, if a user completes the enrollment or sign-ups immediately or soon after the user receives the search result data object via the client computing entity, the search result completion metadata associated with the search result data object indicates immediate engagement from the user. In some embodiments, the search result completion metadata may affect the attractiveness variable data object, as completing the enrollment or sign-up is considered as an attractiveness event similar to a user clicking on the search result data object.

As an example, if the user submits a search query for “weight loss program,” receives search result data objects describing weight loss programs, and then signs up for a weight loss program described in a search result data object of the search result data objects, the search result data object associated with the search result data object comprises search result completion metadata indicating an immediate engagement from the user.

Referring back to FIG. 13, subsequent to and/or in response to step/operation 1303, the example method 1300 proceeds to step/operation 1305. At step/operation 1305, a computing entity (such as the ranking generation computing entity 105 described above in connection with FIG. 1 and FIG. 2) includes means (such as the processing element 205 of the ranking generation computing entity 105 described above in connection with FIG. 2) to generate the plurality of immediate engagement relevance score data objects based at least in part on the search result completion metadata.

For example, if the search result completion metadata of a search event data object associated with the search result data object indicates an immediate engagement, the immediate engagement relevance score data object of the search result data object is higher compared to the immediate engagement relevance score data object of another search result data object that is not associated with any search event data object indicating any immediate engagement.

Additionally, or alternatively, if the search result completion metadata of a search event data object associated with the search result data object indicates multiple immediate engagements (for example, multiple enrollments), the immediate engagement relevance score data object of the search result data object is higher compared to the immediate engagement relevance score data object of another search result data object that is not associated with any search event data object indicating any immediate engagement or associated with only one immediate engagement (for example, only one enrollment).

Referring back to FIG. 13, subsequent to and/or in response to step/operation 1305, the example method 1300 proceeds to step/operation 1307 and ends.

As described above, there are technical challenges, deficiencies and problems associated with database systems, and various example embodiments of the present disclosure overcome such challenges. For example, referring now to FIG. 14, an example method 1400 of generating delayed engagement relevance score data objects in accordance with embodiments of the present disclosure is illustrated.

For example, the example method 1400 may determine a post-search observation time period that is associated with the plurality of search result data objects, retrieve a user profile data object that is associated with the search query data object, retrieve a plurality of clinical event data objects that are associated with the user profile data object and the post-search observation time period, retrieve a plurality of search event data objects associated with the plurality of search result data objects, and generate the plurality of delayed engagement relevance score data objects based at least in part on the plurality of clinical event data objects and the plurality of search event data objects. As such, the example method 1400 may, for example but not limited to, provide technical benefits and advantages such as, but not limited to, improving accuracy and precision in data retrieval from complex network databases and improving user search experience.

As shown in FIG. 14, the example method 1400 starts at step/operation 1402. Subsequent to and/or in response to step/operation 1402, the example method 1400 proceeds to step/operation 1404. At step/operation 1404, a computing entity (such as the ranking generation computing entity 105 described above in connection with FIG. 1 and FIG. 2) includes means (such as the processing element 205 of the ranking generation computing entity 105 described above in connection with FIG. 2) to determine a post-search observation time period that is associated with the plurality of search result data objects.

As described above, the delayed engagement relevance score data object represents engagement associated with a search result data object that does not take place immediately after performing the query search. For example, a medical visit to a physician after a user search for providers would not happen at the same time of the search, but may happen several days after the search. As such, the post-search observation time period sets up a threshold time window from the time that the search query occurred (for the purpose of attributing clinical events as engagements with search result data objects).

As an example, the post search observation window is within six weeks after the query search occurred. In some embodiments, the post search observation window may be longer than or shorter than six weeks.

Referring back to FIG. 14, subsequent to and/or in response to step/operation 1404, the example method 1400 proceeds to step/operation 1406. At step/operation 1406, a computing entity (such as the ranking generation computing entity 105 described above in connection with FIG. 1 and FIG. 2) includes means (such as the processing element 205 of the ranking generation computing entity 105 described above in connection with FIG. 2) to retrieve a user profile data object that is associated with the search query data object.

For example, the search query data object is associated with a user (e.g. the user provided the search query), and the user profile data object is also associated with the same user.

Referring back to FIG. 14, subsequent to and/or in response to step/operation 1406, the example method 1400 proceeds to step/operation 1408. At step/operation 1408, a computing entity (such as the ranking generation computing entity 105 described above in connection with FIG. 1 and FIG. 2) includes means (such as the processing element 205 of the ranking generation computing entity 105 described above in connection with FIG. 2) to retrieve a plurality of clinical event data objects that are associated with the user profile data object retrieved at step/operation 1406 and the post-search observation time period determined at step/operation 1404.

For example, the computing entity retrieves all clinical event data objects that are (1) associated with the user who submitted the search query and (2) occurred within the post-search observation time period from the time that the user initiated the search.

As an example, the user may initiate a search query data object for “primary care physician” and receive search result data objects via a client computing entity, and the post-search observation time period is six weeks. In this example, the computing entity retrieves clinical event data objects that are associated with the user and are associated with event dates that fall between the date that the search result data objects were received and the date of six weeks after the search result data objects were received.

Referring back to FIG. 14, subsequent to and/or in response to step/operation 1408, the example method 1400 proceeds to step/operation 1410. At step/operation 1410, a computing entity (such as the ranking generation computing entity 105 described above in connection with FIG. 1 and FIG. 2) includes means (such as the processing element 205 of the ranking generation computing entity 105 described above in connection with FIG. 2) to retrieve a plurality of search event data objects associated with the plurality of search result data objects.

In some embodiments, the plurality of search event data objects comprise search result view metadata and search result selection metadata. As described above, search result view metadata indicates whether a user has viewed the corresponding search result data objects, and search result selection metadata indicates whether a user has selected the corresponding search result data object.

Referring back to FIG. 14, subsequent to and/or in response to step/operation 1410, the example method 1400 proceeds to step/operation 1412. At step/operation 1412, a computing entity (such as the ranking generation computing entity 105 described above in connection with FIG. 1 and FIG. 2) includes means (such as the processing element 205 of the ranking generation computing entity 105 described above in connection with FIG. 2) to generate a plurality of delayed engagement relevance score data objects based at least in part on the plurality of clinical event data objects and the plurality of search event data objects.

In some embodiments, the computing entity selects a search result data object subset comprising search result data objects that are associated with the search result view metadata indicating that the search result data objects have been viewed by the user, and/or associated with the search result selection metadata indicating that the search result data objects have been selected by the user.

For example, based at least in part on the search event data objects retrieved at step/operation 1410, the computing entity determines one or more search result data objects that have been viewed or selected by the user. The computing entity then generates delayed engagement relevance score data objects for these search result data objects based at least in part on determining syntactic and/or semantic similarities as described herein. In some embodiments, for search result data objects that have not been viewed or selected by the user, the computing entity does not generate delayed engagement relevance score data objects.

In some embodiments, the computing entity determines search result metadata that are associated with search result data objects from the search result data object subset selected as described above. In some embodiments, the search result metadata comprises information such as, but not limited to, healthcare provider name, healthcare service name, and/or the like.

In some embodiments, the computing entity generates delayed engagement relevance score data objects based at least in part on determining syntactic and/or semantic similarities between the search result metadata associated with the search result data objects that have been viewed/selected by user (e.g. search result data objects from the search result data object subset) and the clinical event metadata of clinical event data objects that are associated with clinical events within the post-search observation time period.

Referring now to FIG. 15, an example diagram 1500 illustrates an example of generating delayed engagement relevance score data objects in accordance with some embodiments of the present disclosure.

In the example shown in FIG. 15, the search result data object 1509 is generated during the search event 1503. For example, a user may use the search query “medical test” in the search event 1503, and the search result data object 1509 is generated in response to the search query.

In some embodiments, the search result data object 1509 comprises search result metadata 1515A that describes provider information associated with the search result data object 1509, search result metadata 1515B that describes service information associated with the search result data object 1509, and search result metadata 1515C that describes service information associated with the search result data object 1509. For example, search result metadata 1515A may describe information of a healthcare provider that provides services related to medical tests. Search result metadata 1515B may describe information of a type of medical test that is provided by the healthcare provider (for example, blood count test). Search result metadata 1515B may describe information of another type of medical test that is provided by the healthcare provider (for example, genetic testing).

As described above in connection with at least FIG. 14, example embodiments of the present disclosure retrieve a plurality of search event data objects associated with the plurality of search result data objects, and select a search result data object subset comprising search result data objects that are associated with search event data objects having search result view metadata indicating that the search result data objects have been viewed by the user, or associated with the search result selection metadata indicating that the search result data objects have been selected by the user. In some embodiments, example embodiments of the present disclosure generate delayed engagement relevance score data objects for the search result data objects in the search result data object subset.

In the example shown in FIG. 15, the search result view metadata 1511 indicates that the user has viewed the search result metadata 1515A, the search result metadata 1515B, and the search result metadata 1515C, and the search selection metadata 1513 indicates that the user has clicked on or otherwise selected the search result metadata 1515A, the search result metadata 1515B, and the search result metadata 1515C. As such, the search result data object 1509 is a part of the search result data object subset, and various embodiments of the present disclosure generate a delayed engagement relevance score data object for the search result data object 1509.

As described above in connection with at least FIG. 14, example embodiments of the present disclosure determine a post-search observation time period that is associated with the plurality of search result data objects, retrieve a user profile data object that is associated with the search query data object, and retrieve a plurality of clinical event data objects that are associated with the user profile data object and the post-search observation time period.

In the example shown in FIG. 15, clinical event data objects that are associated with the user who initiated the search event 1503 and are associated with event dates within the post-search observation time period from the search event 1503 include at least the following: a clinical event data object 1501A, a clinical event data object 1501B, and a clinical event data object 1501C. For example, each of the clinical event data objects comprises data and/or information associated with a visit to a healthcare provider by the user.

In some embodiments, each of the example clinical event data objects comprises metadata that provides information associated with the healthcare provider and information associated with the healthcare service that the user received during the visit. For example, the example clinical event data object 1501A comprises clinical event metadata 1505A that describes provider information associated with the clinical event data object 1501A, and clinical event metadata 1507A that describes service information associated with the clinical event data object 1501A. The example clinical event data object 1501B comprises clinical event metadata 1505B that describes provider information associated with the clinical event data object 1501B and clinical event metadata 1507B that describes service information associated with the clinical event data object 1501B. The example clinical event data object 1501C comprises clinical event metadata 1505C that describes provider information associated with the clinical event data object 1501C and clinical event metadata 1507C that describes service information associated with the clinical event data object 1501C.

In some embodiments, the computing entity generates a delayed engagement relevance score data object associated with the search result data object 1509 based at least in part on syntactic and/or semantic matching between the metadata associated with the search result data object 1509 and each of the metadata associated with the clinical event data object 1501A, the clinical event data object 1501B, and the clinical event data object 1501C.

As described above, the computing entity generates the delayed engagement relevance score data objects based at least in part on determining syntactic and/or semantic similarities between the search result metadata associated with the search result data objects and the clinical event metadata of clinical event data objects. In some embodiments, the computing entity determines whether the search result metadata or the clinical event metadata is associated with semantic meaning, generate syntactic embedding vectors and semantic embedding vectors based at least in part on the search result metadata and the clinical event metadata, and calculate syntactic similarity scores or semantic similarity scores based at least in part on the syntactic embedding vectors or the semantic embedding vectors, respectively. In some embodiments, the computing entity generates the delayed engagement relevance score data objects based at least in part on the syntactic similarity scores or the semantic similarity scores.

In the example shown in FIG. 15, the computing entity determines whether the clinical event metadata 1505A, the clinical event metadata 1505B, the clinical event metadata 1505C, and the search result metadata 1515A are associated with semantic meaning.

As an example, the computing entity may determine that the clinical event metadata 1505A, the clinical event metadata 1505B, the clinical event metadata 1505C, and the search result metadata 1515A are associated with semantic meaning. For example, the clinical event data object 1501A may indicate that the clinical event metadata 1505A provides a textual description of a healthcare provider. Similarly, the clinical event data object 1501B may indicate that the clinical event metadata 1505B provides a textual description of a healthcare provider; the clinical event data object 1501C may indicate that the clinical event metadata 1505C provides a textual description of a healthcare provider; and the search result data object 1509 may indicate that the search result metadata 1515A provides a textual description of a healthcare provider. In such an example, the computing entity performs semantic matching (such as, but not limited to, based at least in part on universal sentence encoding model) between the search result metadata 1515A and each of the clinical event metadata 1505A, the clinical event metadata 1505B, the clinical event metadata 1505C to generate semantic similarity scores.

In some examples, the computing entity may determine that the clinical event metadata 1507A, the clinical event metadata 1507B, the clinical event metadata 1507C, the search result metadata 1515B, and the search result metadata 1515C are not associated with semantic meaning. For example, the clinical event data object 1501A may indicate that the clinical event metadata 1507A provides a medical code (for example, a Current Procedural Terminology (CPT) code). Similarly, the clinical event data object 1501B may indicate that the clinical event metadata 1507B provides a medical code (for example, a CPT code); the clinical event data object 1501C may indicate that the clinical event metadata 1507C provides a medical code (for example, a CPT code); the search result data object 1509 may indicate that the search result metadata 1515B and 1515C provide medical codes (for example, CPT codes). In such an example, the computing entity performs syntactic matching (such as, but not limited to, subword TF-IDF) between the search result metadata 1515B and each of the clinical event metadata 1507A, the clinical event metadata 1507B, the clinical event metadata 1507C, and/or between the search result metadata 1515C and each of the clinical event metadata 1507A, the clinical event metadata 1507B, the clinical event metadata 1507C to generate syntactic similarity scores.

While the description above provides examples of generating syntactic and semantic embedding vectors and performing syntactic and semantic matching, it is noted that the scope of the present disclosure is not limited to the description above. For example, various embodiments of the present disclosure may utilize TF-IDF based, word2vec based, and/or transformer based techniques to generate syntactic and/or semantic embedding vectors and/or to perform syntactic and/or semantic matching.

In some embodiments, the computing entity may identify clinical event data object(s) that match search result data objects based at least in part on the syntactic similarity scores and/or the semantic similarity scores.

For example, the computing entity may determine thresholds for syntactic similarity scores and thresholds for semantic similarity scores. If the syntactic similarity scores and/or the semantic similarity scores satisfy the corresponding threshold(s), the computing entity determines that the corresponding clinical event data object(s) match the corresponding search result data object, and generates a delayed engagement relevance score data object for the search result data object indicating that there is a delayed engagement with the search result data object by the user. In some embodiments, performing the matching is to calculate, for example but not limited to, a cosine similarity between mathematical vector representations of the user-interacted search results and mathematical vector representations of the clinical events. In some embodiments, the thresholds are set heuristically.

As such, various embodiments of the present disclosure provide technical improvements and advantages in addressing technical problems related to data retrieval in computer database systems. For example, various embodiments of the present disclosure generate delayed engagement relevance score data objects, which attribute delayed clinical events to search events by syntactically and semantically matching clinical event metadata with search result metadata, and therefore improving accuracy in determining whether a search result is relevant to a user based at least in part on whether there is delayed engagement of the search result from the user.

Referring back to FIG. 14, subsequent to and/or in response to step/operation 1412, the example method 1400 proceeds to step/operation 1414 and ends.

f. Exemplary Techniques for Generating Outcome Relevance Score Data Objects

As described above, there are technical challenges, deficiencies and problems associated with database systems, and various example embodiments of the present disclosure overcome such challenges. For example, referring now to FIG. 16, an example method 1600 of generating an outcome relevance score data object in accordance with embodiments of the present disclosure is illustrated.

For example, the example method 1600 may determine a clinical event data object associated with a search result data object of the plurality of search result data objects, generate a cost difference variable data object, and generate an outcome relevance score data object for the search result data object. As such, the example method 1600 may, for example but not limited to, provide technical benefits and advantages such as, but not limited to, improving accuracy and precision in data retrieval from complex network databases and improving user search experience.

As shown in FIG. 16, the example method 1600 starts at step/operation 1602. Subsequent to and/or in response to step/operation 1602, the example method 1600 proceeds to step/operation 1604. At step/operation 1604, a computing entity (such as the ranking generation computing entity 105 described above in connection with FIG. 1 and FIG. 2) includes means (such as the processing element 205 of the ranking generation computing entity 105 described above in connection with FIG. 2) to determine a clinical event data object associated with a search result data object of the plurality of search result data objects.

In some embodiments, the plurality of search result data objects are generated in response to a search query from a user. In some embodiments, the user is associated with a user profile data object.

As an example, a search query data object is generated based at least in part on a search query “medical test” from a user, and the plurality of search result data objects associated with the search query data object provide data and/or information that describes different search results (e.g. different medical tests).

In some embodiments, the computing entity performs syntactic and/or semantic matching between the search result data object and clinical event data objects from a clinical event database to determine a clinical event data object that is associated with the search result data object, similar those described in connection with at least FIG. 14 and FIG. 15.

Continuing from the example above, the computing entity may determine that a search result data object provides data and/or information related to a blood test service provided by a medical laboratory. In this example, the computing entity determines that a clinical event data object associated with the search result data object describes the blood test service provided by the medical laboratory.

While the description above provides an example of determining a clinical event data object associated with a search result data object, it is noted that the scope of the present disclosure is not limited to the description above. In some examples, an example method may determine a clinical event data object associated with a search result data object based at least in part on, for example but not limited to, natural language processing techniques such as, but not limited to, named entity recognition, text classification, keyword extraction, and/or the like.

Referring back to FIG. 16, subsequent to and/or in response to step/operation 1604, the example method 1600 proceeds to step/operation 1606. At step/operation 1606, a computing entity (such as the ranking generation computing entity 105 described above in connection with FIG. 1 and FIG. 2) includes means (such as the processing element 205 of the ranking generation computing entity 105 described above in connection with FIG. 2) to generate a cost difference variable data object based at least in part on inputting the user profile data object to an event-true cost-estimation machine learning model and an event-false cost-estimation machine learning model.

In some embodiments, the event-true cost-estimation machine learning model and the event-false cost-estimation machine learning model are both associated with the clinical event data object determined at step/operation 1604.

As described above, the event-true cost-estimation machine learning model is a machine learning model that is trained to generate predicted future cost score data object representing estimated/predicted future cost related to healthcare if the user engages in the clinical event described in the clinical event data object (i.e. determined at step/operation 1604). In particular, the event-true cost-estimation machine learning model receives the user profile data object as an input. The user profile data object comprises user profile metadata such as, but not limited to, user socio-economic metadata, user demographics characteristics metadata, user search history metadata, user medical history metadata, and/or the like. Based at least in part on the user profile metadata, the event-true cost-estimation machine learning model generates a predicted future cost score data object that represents estimated/predicted future cost of healthcare associated with user if the user engages in the clinical event described in the clinical event data object determined at step/operation 1604. In other words, the predicted future cost score data object is not the cost of engaging in the clinical event itself; rather, the predicted future cost score data object (from the event-true cost-estimation machine learning model) provides an estimation/prediction on future medical expenses of the user after the user engages in the clinical event. As such, the event-true cost-estimation machine learning model generates estimated/predicted future cost of healthcare, which provides an estimation/prediction of the user's future medical expenses as impacted by engaging the clinical event.

As described above, the event-false cost-estimation machine learning model is a machine learning model that is trained to generate predicted future cost score data objects that represent estimated/predicted future cost related to healthcare if the user does not engage in the clinical event described in the clinical event data object (i.e. determined at step/operation 1604). In particular, the event-false cost-estimation machine learning model receives the user profile data object as an input. The user profile data object comprises user profile metadata such as, but not limited to, user socio-economic metadata, user demographics characteristics metadata, user search history metadata, user medical history metadata, and/or the like. Based at least in part on the user profile metadata, the event-false cost-estimation machine learning model generates a predicted future cost score data object that represents an estimated/predicted future cost of healthcare associated with user if the user does not engage in the clinical event described in the clinical event data object that is determined at step/operation 1604. In other words, the predicted future cost score data object is not the cost of engaging in the clinical event itself; rather, the predicted future cost score data object (from the event-false cost-estimation machine learning model) provides an estimation/prediction on future medical expenses of the user if the user decides not to engage in the clinical event. As such, the event-false cost-estimation machine learning model generates estimated/predicted future cost of healthcare, which provides an estimation/prediction of the user's future medical expenses as impacted by not engaging the clinical event.

Additional details of training the event-true cost-estimation machine learning model and the event-false cost-estimation machine learning model are described in connection with at least FIG. 17 and FIG. 18.

In some embodiments, the cost difference variable data object is generated based at least in part on calculating a difference between the predicted future cost score data object generated by the event-true cost-estimation machine learning model and the predicted future cost score data object generated by the event-false cost-estimation machine learning model. In other words, the cost difference variable data object indicates a difference between the estimated/predicted future medical cost of the user if the user engages in the clinical event associated with the search result data object and the estimated/predicted future medical cost of the user if the user does not engage in the clinical event associated with the search result data object.

Continuing from the example above, the computing entity may generate a first predicted future cost score data object by providing the user profile data object to the event-true cost-estimation machine learning model, and generate a second predicted future cost score data object by providing the user profile data object to the event-false cost-estimation machine learning model. In this example, the computing entity generates a cost difference variable data object based at least in part on calculating a difference between the first predicted future cost score data object and the second predicted future cost score data object.

Referring back to FIG. 16, subsequent to and/or in response to step/operation 1606, the example method 1600 proceeds to step/operation 1608. At step/operation 1608, a computing entity (such as the ranking generation computing entity 105 described above in connection with FIG. 1 and FIG. 2) includes means (such as the processing element 205 of the ranking generation computing entity 105 described above in connection with FIG. 2) to generate an outcome relevance score data object associated with the search result data object based at least in part on the cost difference variable data object.

In some embodiments, the outcome relevance score data object comprises the cost difference variable data object. As described above, the cost difference variable data object indicates the difference/change in the estimated/predicted future medical cost of the user if the user engages in the clinical event associated with the search result data object and the estimated/predicted future medical cost of the user if the user does not engage in the clinical event associated with the search result data object. As such, the outcome relevance score data object provides a quantitative measure that reflects the value of the search result data object. In other words, the outcome relevance score data object can infer medical cost saving (or medical cost increase) that the search result data object can provide to the user.

Continuing from the example above, the computing entity determines the cost difference variable data object as the outcome relevance score data object for the search result data object representing the blood test provided by a medical laboratory. In this example, the outcome relevance score data object represents cost saving on future medical expenses that the blood test may bring. For example, if the user takes the blood test, the blood test can reveal potential health problems associated with the user (for example, signs of a disease), and the user may receive medical treatment to address these potential health problems before such problems become onset. If the user does not take the blood test, the identification of potential health problems associated with the user will be delayed, which in turn can cause a higher medical expense to address these health problems when they become onset or are at a late stage.

Referring back to FIG. 16, subsequent to and/or in response to step/operation 1608, the example method 1600 proceeds to step/operation 1610 and ends.

Referring now to FIG. 17, an example method 1700 of training event-true cost-estimation machine learning model and the event-false cost-estimation machine learning model in accordance with embodiments of the present disclosure is illustrated.

For example, the example method 1700 may train a probability matching machine learning model, identify a first probability-matched user profile data object subset and a second probability-matched user profile data object subset, and train the event-true cost-estimation machine learning model and the event-false cost-estimation machine learning model. As such, the example method 1700 may, for example but not limited to, provide technical benefits and advantages such as, but not limited to, improving accuracy and precision in data retrieval from complex network databases and improving user search experience.

As shown in FIG. 17, the example method 1700 starts block C, which is connected to step/operation 1606 of FIG. 16. As described above, at step/operation 1606 of FIG. 16, the computing entity generates the cost difference variable data object. As a part of generating the cost difference variable data object, the computing entity performs the example method 1700 shown in FIG. 17 to train the event-true cost-estimation machine learning model and the event-false cost-estimation machine learning model.

At step/operation 1701, a computing entity (such as the ranking generation computing entity 105 described above in connection with FIG. 1 and FIG. 2) includes means (such as the processing element 205 of the ranking generation computing entity 105 described above in connection with FIG. 2) to train a probability matching machine learning model associated with the clinical event data object.

As described above in connection with at least FIG. 16, the computing entity may determine a client event data object that is associated with the search result data object. In some embodiments, the computing entity identifies one or more user profile data objects that are associated with the clinical event data object and one or more user profile data objects that are not associated with the clinical event data object, and trains the probability matching machine learning model based at least in part on the user profile data objects.

For example, the computing entity may communicate with a user profile database (such as, but not limited to, the user profile database 402 described above in connection with at least FIG. 4) and/or a clinical event database (such as, but not limited to, the clinical event database 404 described above in connection with at least FIG. 4). The computing entity may curate two groups of user profile data objects, where a first group of user profile data objects is associated with the client event data object and a second group of user profile data objects is not associated with the client event data object.

As described above, the user profile data objects comprise user profile metadata that includes, but are not limited to, user socio-economic metadata, user demographics characteristics metadata, user search history metadata, user medical history metadata, and/or the like. In some embodiments, the computing entity trains the probability matching machine learning model based at least in part on the user profile metadata.

For example, the computing entity trains the probability matching machine learning model to identify data patterns in user profile metadata that contribute to or affect the likelihood that the user engages in the clinical event described in the clinical event data object. In this example, the probability matching machine learning model is trained to receive user profiles data objects as input and generate propensity score data objects indicating the likelihood/probability that users associated with the user profile data objects engage in the clinical event. In some embodiments, the probability matching machine learning model generates the propensity score data objects based at least in part on the user characteristics (such as, but not limited to, age group, gender, socio-economic group, risk group, and/or the like).

Referring back to FIG. 17, subsequent to and/or in response to step/operation 1701, the example method 1700 proceeds to step/operation 1703. At step/operation 1703, a computing entity (such as the ranking generation computing entity 105 described above in connection with FIG. 1 and FIG. 2) includes means (such as the processing element 205 of the ranking generation computing entity 105 described above in connection with FIG. 2) to identify a first probability-matched user profile data object subset and a second probability-matched user profile data object sub set.

As described above, the probability matching machine learning model generates propensity score data objects indicating the likelihood/probability that a user engages with a clinical event based at least in part on the user profile data objects associated with the user. In some embodiments, the computing entity provides user profile data objects (for example, the user profile data objects stored in the user profile database 402 described above in connection with FIG. 4) to the probability matching machine learning model as inputs, and the probability matching machine learning model generates the probability/likelihood that users corresponding to the user profile data objects engage in the clinical event.

In some embodiments, the computing entity determines a first probability-matched user profile data object subset comprising user profile data objects associated with the propensity score data objects satisfying a threshold (i.e. the users are likely to engage in the clinical event). In some embodiments, user profile data objects in the first probability-matched user profile data object subset are associated with propensity score data objects being within a range that indicates the user engaging the clinical event.

In some embodiments, the computing entity determines a second probability-matched user profile data object subset comprising user profile data objects associated with the propensity score data objects that does not satisfy a threshold (i.e. the users are not likely to engage in the clinical event). In some embodiments, user profile data objects in the second probability-matched user profile data object subset are associated with propensity score data objects being within a range that indicates the user not engaging the clinical event.

As such, the computing entity utilizes propensity score stratification to generate two groups of comparable users by identify, from a plurality of user profile data objects and based at least in part on a probability matching machine learning model, a first probability-matched user profile data object subset that is associated with the clinical event data object and a second probability-matched user profile data object subset that is not associated with the clinical event data object.

Referring back to FIG. 17, subsequent to and/or in response to step/operation 1703, the example method 1700 proceeds to step/operation 1705. At step/operation 1705, a computing entity (such as the ranking generation computing entity 105 described above in connection with FIG. 1 and FIG. 2) includes means (such as the processing element 205 of the ranking generation computing entity 105 described above in connection with FIG. 2) to train the event-true cost-estimation machine learning model and the event-false cost-estimation machine learning model.

As described above, the user profile data objects comprise user profile metadata that includes, but are not limited to, user socio-economic metadata, user demographics characteristics metadata, user search history metadata, user medical history metadata, and/or the like. In some embodiments, the user profile data objects are associated with user healthcare cost data objects that indicate medical and other healthcare related costs associated with the users.

In some embodiments, the computing entity trains the event-true cost-estimation machine learning model based at least in part on providing (1) the first probability-matched user profile data object subset and (2) user healthcare cost data objects that are associated with the first probability-matched user profile data object subset to the event-true cost-estimation machine learning model. In some embodiments, the user healthcare cost data objects are associated with medical and other healthcare related costs during a post-search prediction time period (for example, but not limited to, three months).

Through training, the event-true cost-estimation machine learning model generates predicted future cost score data objects representing estimated/predicted future healthcare costs of users who engage in the clinical event by recognizing data patterns from user profile data objects in the first probability-matched user profile data object subset. In some embodiments, the predicted future cost score data objects representing estimated/predicted future healthcare costs during the post-search prediction time period. For example, if user healthcare cost data objects that are associated with the first probability-matched user profile data object and associated with the next three months after the search are provided to the event-true cost-estimation machine learning model for training, the event-true cost-estimation machine learning model generates predicted future cost score data objects representing estimated/predicted future healthcare costs of users for the next three months if the user engages in the clinical event.

In some embodiments, the computing entity trains the event-false cost-estimation machine learning model based at least in part on providing (1) the second probability-matched user profile data object subset and (2) the user healthcare cost data objects that are associated with the second probability-matched user profile data object subset to the event-false cost-estimation machine learning model. In some embodiments, the user healthcare cost data objects are associated with medical and other healthcare related costs during a post-search prediction time period (for example, but not limited to, three months).

Through training, the event-false cost-estimation machine learning model generates predicted future cost score data objects representing estimated/predicted future healthcare costs of users who do not engage in the clinical event by recognizing data patterns from user profile data objects in the second probability-matched user profile data object subset. For example, if user healthcare cost data objects that are associated with the second probability-matched user profile data object and associated with the next three months after the search are provided to the event-false cost-estimation machine learning model for training, the event-false cost-estimation machine learning model generates predicted future cost score data objects representing estimated/predicted future healthcare costs of users for the next three months if the user does not engage in the clinical event.

Referring back to FIG. 17, subsequent to and/or in response to step/operation 1705, the example method 1700 returns to block D. As described above in connection with at least FIG. 16, the computing entity generates a cost difference variable data object based at least in part on inputting the user profile data object to the event-true cost-estimation machine learning model and the event-false cost-estimation machine learning model that are trained based at least in part on the example method 1700 described in connection with FIG. 17.

Referring now to FIG. 18, an example diagram 1800 illustrates an example method of generating outcome relevance score data objects in accordance with some embodiments of the present disclosure.

As described above, the outcome relevance score data object represents the quantified value/affordability of each search result data object in the long term. In the example shown in FIG. 18, the example method implements a two-model approach to generate the outcome relevance score data object. The machine learning models in the two-model approach include the event-true cost-estimation machine learning model 1802 and the event-false cost-estimation machine learning model 1804.

In some embodiments, the event-true cost-estimation machine learning model 1802 and the event-false cost-estimation machine learning model 1804 are trained based at least in part on the user profile metadata 1806 associated with the first probability-matched user profile data object subset 1808 and the second probability-matched user profile data object subset 1810, respectively. In this example, the first probability-matched user profile data object subset 1808 comprises user profile data objects associated with propensity score data objects satisfying a predetermined threshold (e.g. users who are likely to engage in the clinical event). The second probability-matched user profile data object subset 1810 comprises user profile data objects associated with propensity score data objects not satisfying the predetermined threshold (e.g. users who are not likely to engage in the clinical event).

In some embodiments, the event-true cost-estimation machine learning model 1802 and/or the event-false cost-estimation machine learning model 1804 may be Random Forest machine learning models. Additionally, or alternatively, the event-true cost-estimation machine learning model 1802 and/or the event-false cost-estimation machine learning model 1804 may be other machine learning based models (e.g. linear regression) or deep learning based models (e.g. long short-term memory (LSTM)).

In some embodiments, the event-true cost-estimation machine learning model 1802 and the event-false cost-estimation machine learning model 1804 are trained to generate estimated/predicted medical expenses (e.g. predicted future cost score data objects) in a future time frame (e.g. a post-search prediction time period). In some embodiments, the duration of the future time frame can be adjusted based at least in part on business requirements. In some embodiments, the computing entity infers medical cost saving of the clinical event by applying the event-true cost-estimation machine learning model 1802 and the event-false cost-estimation machine learning model 1804 to predict future medical expenses of matched populations.

For example, when inferring a specific user u for event k, the difference between the predicted future cost score data object from the event-true cost-estimation machine learning model 1802 and the predicted future cost data object from the event-false cost-estimation machine learning model 1804 is the estimated medical saving of having event k (i.e. the affordability metric that is represented by the outcome relevance score data object). As such, various embodiments of the present disclosure overcome technical challenges and difficulties in data retrievals from complex network database systems by generating outcome relevance score data objects, which increases relevance of search result data objects and relevance of the ranking of the search result data objects.

### V. CONCLUSION

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus comprising at least one processor and at least one non-transitory memory comprising a computer program code, the at least one non-transitory memory and the computer program code configured to, with the at least one processor, cause the apparatus to:
retrieve an initial ranking data object associated with a plurality of search result data objects, wherein the plurality of search result data objects are associated with a search query data object;
retrieve a plurality of relevance score data objects, wherein each of the plurality of relevance score data objects is associated with one of the plurality of search result data objects and one of a plurality of relevance measures;
generate a plurality of ranking comparison score data objects associated with the plurality of relevance measures, wherein the at least one non-transitory memory and the computer program code that are configured to generate the plurality of ranking comparison score data objects are configured to, with the at least one processor, cause the apparatus to:
determine, from the plurality of relevance score data objects, a relevance score data object subset associated with the plurality of search result data objects and associated with a relevance measure of the plurality of relevance measures;
generate, based at least in part on the relevance score data object subset, a per-measure optimized ranking data object associated with the plurality of search result data objects and the relevance measure; and
generate a ranking comparison score data object associated with the relevance measure based at least in part on the per-measure optimized ranking data object and the initial ranking data object;
generate a multi-measure optimized ranking data object associated with the plurality of search result data objects based at least in part on inputting the plurality of ranking comparison score data objects to a multi-measure ranking optimization machine learning model; and
perform one or more prediction-based actions based at least in part on the multi-measure optimized ranking data object.

2. The apparatus of claim 1, wherein, when retrieving the initial ranking data object, the at least one non-transitory memory and the computer program code are configured to, with the at least one processor, cause the apparatus to:
retrieve a user profile data object associated with the search query data object, wherein the user profile data object comprises user profile metadata; and
generate a plurality of user feature vectors associated with the user profile data object based at least in part on the user profile metadata.

3. The apparatus of claim 2, wherein the plurality of user feature vectors comprises one or more of user socio-economics embedding vectors, user demographics characteristics vectors, user search history embedding vectors, and user medical history embedding vectors.

4. The apparatus of claim 2, wherein the at least one non-transitory memory and the computer program code are configured to, with the at least one processor, cause the apparatus to:
generate a plurality of query feature vectors based at least in part on the search query data object, wherein the plurality of query feature vectors comprises one or more of query embedding vectors and query-item relevance vectors.

5. The apparatus of claim 4, wherein the at least one non-transitory memory and the computer program code are configured to, with the at least one processor, cause the apparatus to:
generate the initial ranking data object based at least in part on the plurality of user feature vectors and the plurality of query feature vectors.

6. The apparatus of claim 1, wherein the plurality of relevance score data objects comprises a plurality of textual relevance score data objects, a plurality of engagement relevance score data objects, and a plurality of outcome relevance score data objects.

7. The apparatus of claim 6, wherein the at least one non-transitory memory and the computer program code are configured to, with the at least one processor, cause the apparatus to:
generate a plurality of query feature vectors based at least in part on the search query data object;
determine a plurality of search result metadata that are associated with the plurality of search result data objects; and
generate the plurality of textual relevance score data objects based at least in part on the plurality of search result metadata and the plurality of query feature vectors.

8. The apparatus of claim 6, wherein the at least one non-transitory memory and the computer program code are configured to, with the at least one processor, cause the apparatus to:
retrieve a plurality of search event data objects associated with the plurality of search result data objects, wherein the plurality of search event data objects comprises search result selection metadata;
generate one or more attractiveness variable data objects, one or more examination variable data objects, and one or more satisfaction variable data objects associated with the plurality of search result data objects based at least in part on the search result selection metadata; and
generate the plurality of engagement relevance score data objects based at least in part on inputting the one or more attractiveness variable data objects, the one or more examination variable data objects, and the one or more satisfaction variable data objects to an engagement relevance machine learning model.

9. The apparatus of claim 6, wherein the plurality of engagement relevance score data objects comprises a plurality of immediate engagement relevance score data objects and a plurality of delayed engagement relevance score data objects.

10. The apparatus of claim 9, wherein the at least one non-transitory memory and the computer program code are configured to, with the at least one processor, cause the apparatus to:
retrieve a plurality of search event data objects associated with the plurality of search result data objects, wherein the plurality of search event data objects comprises search result completion metadata; and
generate the plurality of immediate engagement relevance score data objects based at least in part on the search result completion metadata.

11. The apparatus of claim 9, wherein the at least one non-transitory memory and the computer program code are configured to, with the at least one processor, cause the apparatus to:
determine a post-search observation time period that is associated with the plurality of search result data objects;
retrieve a user profile data object that is associated with the search query data object;
retrieve a plurality of clinical event data objects that are associated with the user profile data object and the post-search observation time period;
retrieve a plurality of search event data objects associated with the plurality of search result data objects; and
generate the plurality of delayed engagement relevance score data objects based at least in part on the plurality of clinical event data objects and the plurality of search event data objects.

12. The apparatus of claim 9, wherein the at least one non-transitory memory and the computer program code are configured to, with the at least one processor, cause the apparatus to:
determine a clinical event data object associated with a search result data object of the plurality of search result data objects, wherein the search query data object is associated with a user profile data object;
generate a cost difference variable data object based at least in part on inputting the user profile data object to an event-true cost-estimation machine learning model and an event-false cost-estimation machine learning model associated with the clinical event data object; and
generate an outcome relevance score data object associated with the search result data object based at least in part on the cost difference variable data object.

13. The apparatus of claim 12, wherein the at least one non-transitory memory and the computer program code are configured to, with the at least one processor, cause the apparatus to:
identify, from a plurality of user profile data objects and based at least in part on a probability matching machine learning model, a first probability-matched user profile data object subset that is associated with the clinical event data object and a second probability-matched user profile data object subset that is not associated with the clinical event data object; and
train the event-true cost-estimation machine learning model based at least in part on the first probability-matched user profile data object subset and the event-false cost-estimation machine learning model based at least in part on the second probability-matched user profile data object subset.

14. The apparatus of claim 13, wherein the at least one non-transitory memory and the computer program code are configured to, with the at least one processor, cause the apparatus to:
train the probability matching machine learning model based at least in part on one or more user profile data objects that are associated with the clinical event data object and one or more user profile data objects that are not associated with the clinical event data object.

15. A computer-implemented method comprising:
retrieving, using one or more processors, an initial ranking data object associated with a plurality of search result data objects, wherein the plurality of search result data objects are associated with a search query data object;
retrieving, using the one or more processors, a plurality of relevance score data objects, wherein each of the plurality of relevance score data objects is associated with one of the plurality of search result data objects and one of a plurality of relevance measures;
generating, using the one or more processors, a plurality of ranking comparison score data objects associated with the plurality of relevance measures, comprising:
determining, from the plurality of relevance score data objects, a relevance score data object subset associated with the plurality of search result data objects and associated with a relevance measure of the plurality of relevance measures;
generating, based at least in part on the relevance score data object subset, a per-measure optimized ranking data object associated with the plurality of search result data objects and the relevance measure; and
generating a ranking comparison score data object associated with the relevance measure based at least in part on the per-measure optimized ranking data object and the initial ranking data object;
generating, using the one or more processors, a multi-measure optimized ranking data object associated with the plurality of search result data objects based at least in part on inputting the plurality of ranking comparison score data objects to a multi-measure ranking optimization machine learning model; and
performing, using the one or more processors, one or more prediction-based actions based at least in part on the multi-measure optimized ranking data object.

16. The computer-implemented method of claim 15, wherein retrieving the initial ranking data object comprising:
retrieving a user profile data object associated with the search query data object, wherein the user profile data object comprises user profile metadata; and
generating a plurality of user feature vectors associated with the user profile data object based at least in part on the user profile metadata.

17. The computer-implemented method of claim 16, wherein the plurality of user feature vectors comprises one or more of user socio-economics embedding vectors, user demographics characteristics vectors, user search history embedding vectors, and user medical history embedding vectors.

18. The computer-implemented method of claim 16, further comprising:
generating a plurality of query feature vectors based at least in part on the search query data object, wherein the plurality of query feature vectors comprises one or more of query embedding vectors and query-item relevance vectors.

19. The computer-implemented method of claim 18, further comprising:
generating the initial ranking data object based at least in part on the plurality of user feature vectors and the plurality of query feature vectors.

20. A computer program product comprising at least one non-transitory computer-readable storage medium having computer-readable program code portions stored therein, the computer-readable program code portions comprising an executable portion configured to:
retrieve an initial ranking data object associated with a plurality of search result data objects, wherein the plurality of search result data objects are associated with a search query data object;
retrieve a plurality of relevance score data objects, wherein each of the plurality of relevance score data objects is associated with one of the plurality of search result data objects and one of a plurality of relevance measures;
generate a plurality of ranking comparison score data objects associated with the plurality of relevance measures, wherein the computer-readable program code portions that are configured to generate the plurality of ranking comparison score data objects comprise the executable portion configured to:
determine, from the plurality of relevance score data objects, a relevance score data object subset associated with the plurality of search result data objects and associated with a relevance measure of the plurality of relevance measures;
generate, based at least in part on the relevance score data object subset, a per-measure optimized ranking data object associated with the plurality of search result data objects and the relevance measure; and
generate a ranking comparison score data object associated with the relevance measure based at least in part on the per-measure optimized ranking data object and the initial ranking data object;
generate a multi-measure optimized ranking data object associated with the plurality of search result data objects based at least in part on inputting the plurality of ranking comparison score data objects to a multi-measure ranking optimization machine learning model; and
perform one or more prediction-based actions based at least in part on the multi-measure optimized ranking data object.
